(19) United States
(12) Patent Application Publication
(10) Pub. No.: US 2026/0039446 A1
(43) Pub. Date: Feb. 5, 2026

(54) METHODS FOR DETERMINING FULL-DUPLEX (FD) OR NON-FD OPERATION

(71) Applicant: InterDigital Patent Holdings, Inc., Wilmington, DE (US)

(72) Inventors: Nazli Khan Beigi, Longueuil (CA); Jonghyun Park, Syosset, NY (US); Moon IL Lee, Melville, NY (US); Paul Marinier, Brossard (CA); Aata EI Hamss, Laval (CA); Virgile Garcia, Antibes (FR)

(21) Appl. No.: 18/794,656

(22) Filed: Aug. 5, 2024

(51) Int. Cl. H04L 5/14; H04W 72/044; H04W 72/542

(52) U.S. Cl. CPC H04L 5/14; H04W 72/044; H04W 72/542

(57) ABSTRACT

A method performed by a WTRU includes receiving configuration information for a serving cell indicating uplink (UL) resources associated with a subband full duplex (SBFD) mode of operation and receiving timing information for one or more synchronization signal blocks (SSBs) associated with a neighbor cell. The method includes determining at least one SSB will overlap in time with one of the UL resources. The method includes receiving scheduling information indicating at least one of the UL resources to send an UL transmission. The at least one of the UL resources overlaps in time with the at least one SSB. The method includes measuring a reference signal received power (RSRP) of an SSB associated with the neighbor cell and determining, based on a measurement of the RSRP of the SSB exceeding an RSRP threshold, to refrain from sending the UL transmission.

### BACKGROUND

Third Generation Partnership Project (3GPP) technical specifications for Fifth Generation (5G) New Radio (NR) networks are likely to support duplex operation in the near future. This technology may provide a foundation for improvements to conventional time domain duplex (TDD) operation and may enable enhanced uplink (UL) coverage, improved capacity, and reduced latency. Conventional TDD operates by splitting the time domain between the uplink and downlink transmission directions. Network (e.g., base station) support for full duplex operation, or more specifically, subband non-overlapping full duplex (SBFD) within a conventional TDD band is currently being investigated.

In full-duplex (FD) (e.g., SBFD) systems, when a synchronization signal block (SSB) transmission coincides with an SBFD symbol, the SBFD-capable wireless transmit/receive units (WTRUs) may consider the corresponding symbol as a non-SBFD symbol that may be reserved for downlink (DL) use only. That is, the SBFD symbol may be “converted” to a non-SBFD DL-only symbol and WTRUs may not transmit during SBFD symbols in the configured UL subband(s). The conversion of an SBFD symbol to a non-SBFD DL symbol may be due to collision handling and to reduce the impact of CLI caused by UL transmissions in UL subbands, on monitoring, detecting, receiving, and/or measuring transmissions (e.g., SSBs) in DL subbands of the corresponding SBFD symbol.

### SUMMARY

A method performed by a WTRU includes receiving configuration information for a serving cell indicating uplink (UL) resources associated with a subband full duplex (SBFD) mode of operation and receiving timing information for one or more synchronization signal blocks (SSBs) associated with a neighbor cell. The method includes determining based on the configuration information and the timing information that at least one SSB will overlap in time with one of the UL resources associated with the SBFD mode of operation. The method includes receiving scheduling information indicating at least one of the UL resources to send an UL transmission. The at least one of the UL resources overlaps in time with the at least one SSB. The method includes measuring a reference signal received power (RSRP) of an SSB associated with the neighbor cell and determining, based on a measurement of the RSRP of the SSB exceeding an RSRP threshold, to refrain from sending the UL transmission. The method includes sending a message to a base station associated with the serving cell. The message indicates the WTRU refrained from sending the UL transmission.

Another method performed by a WTRU includes receiving first configuration information indicating resources associated with a subband full duplex (SBFD) mode of operation in a serving cell. The method includes receiving configuration information indicating one or more set of resources for determining channel state information (CSI). The configured one or more set of resources for determining CSI may be from a first set of resources or a second set of resources. The first set of resources are part of the resources associated with the SBFD mode, and the second set of resources are not part of the resources associated with the SBFD mode. The method includes receiving a first CSI report configuration and a second CSI report configuration wherein the first CSI report configuration provides parameters for reporting CSI determined based on the first set of resources, and wherein the second CSI report configuration provides parameters for reporting CSI determined based on the second set of resources.

The method includes receiving timing information for one or more synchronization signal block (SSB) transmissions associated with the serving cell and determining, based on the received timing information, that at least one of the first set of resources will overlap in time with the one or more SSB transmissions. The method includes determining CSI based on the first set of resources that overlap in time with the one or more SSB transmissions. The method includes determining, based on one or more of a measured reference signal received power (RSRP) associated with the serving cell or a measured crosslink interference (CLI), to report the measured CSI from one or more reference signals received in the first set of resources using the first CSI report configuration or using the second CSI report configuration. The method includes sending, to a base station associated with the serving cell, a CSI report including CSI determined based on the first set of resources or in the second set of resources.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a diagram illustrating an example scenario in which cross-link interference may impact SBFD operation;

FIG. 3 is a diagram illustrating an example structure of SBFD resources;

FIG. 4 is a diagram illustrating an example scenario in which an SSB transmission performed in one cell may serve as an indication to convert SBFD resources configured for another cell;

FIG. 5 is a flow diagram illustrating steps as may be performed by a WTRU for determining a CSI reporting configuration; and

FIG. 6 is a flow diagram illustrating steps as may be performed by a WTRU for determining a mode of operation (e.g., an SBFD or non-SBFD mode of operation).

### DETAILED DESCRIPTION

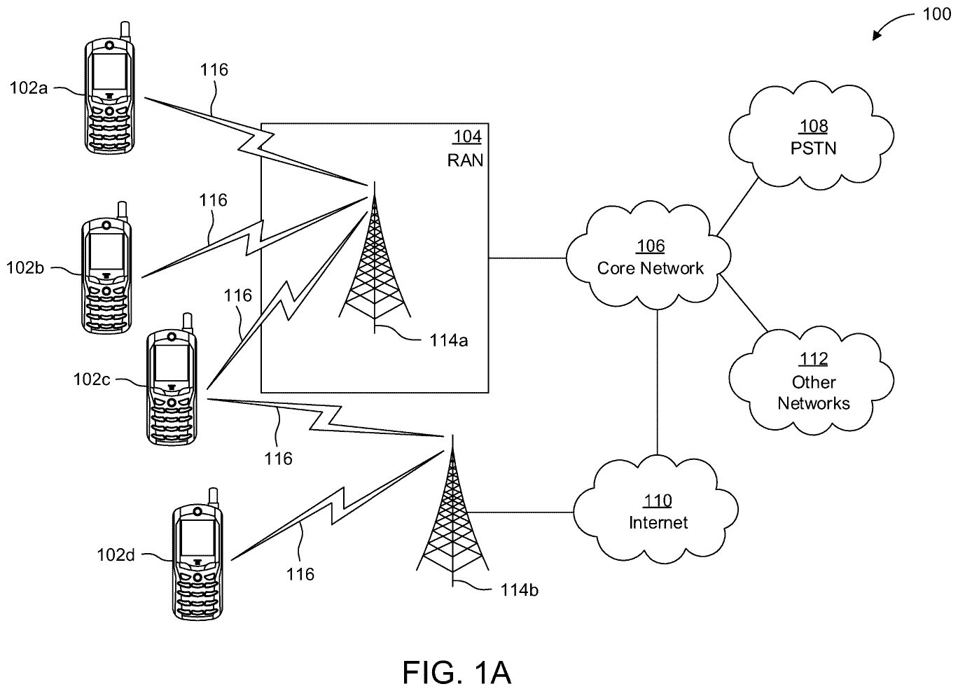

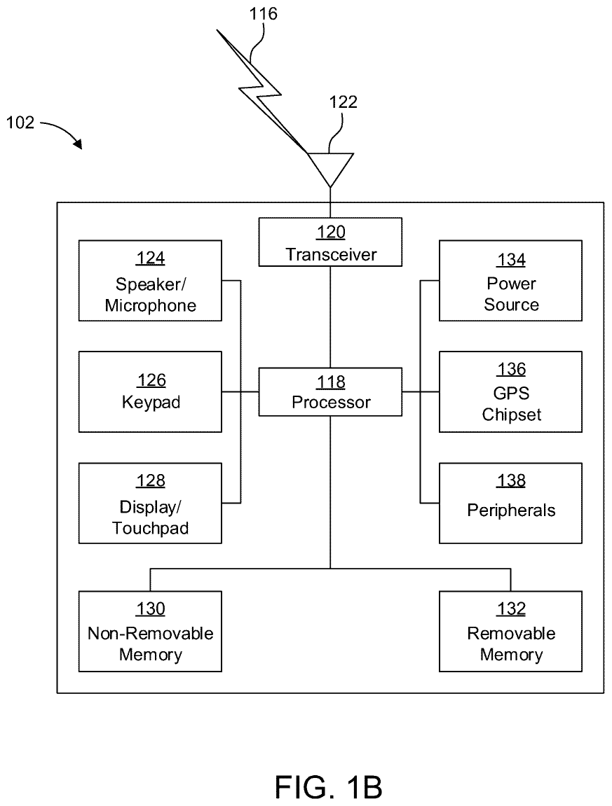

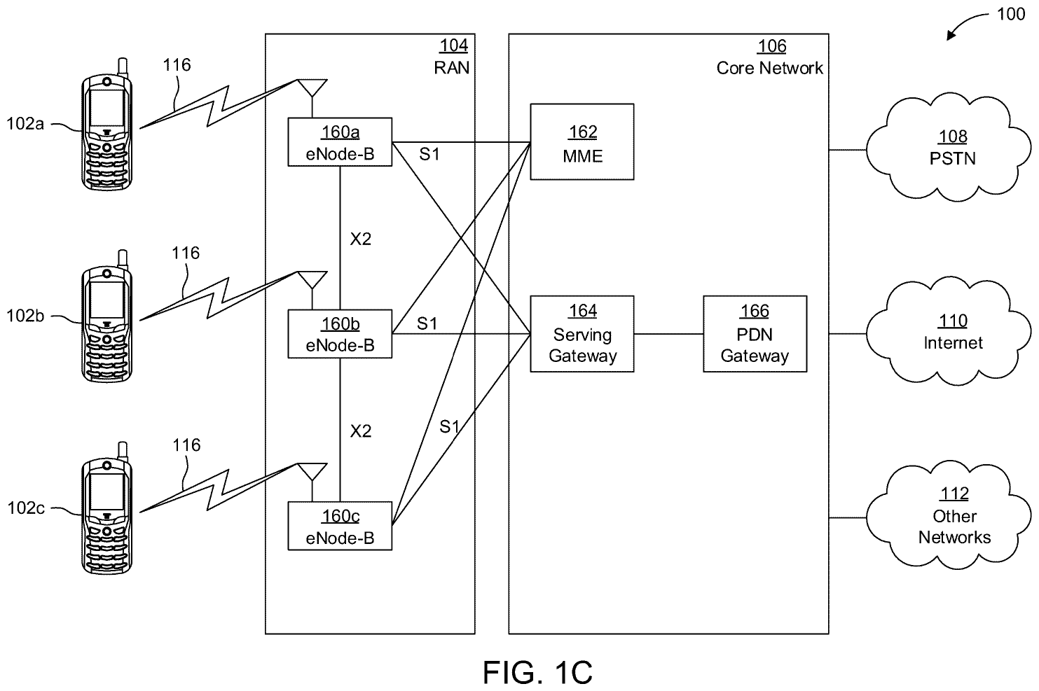

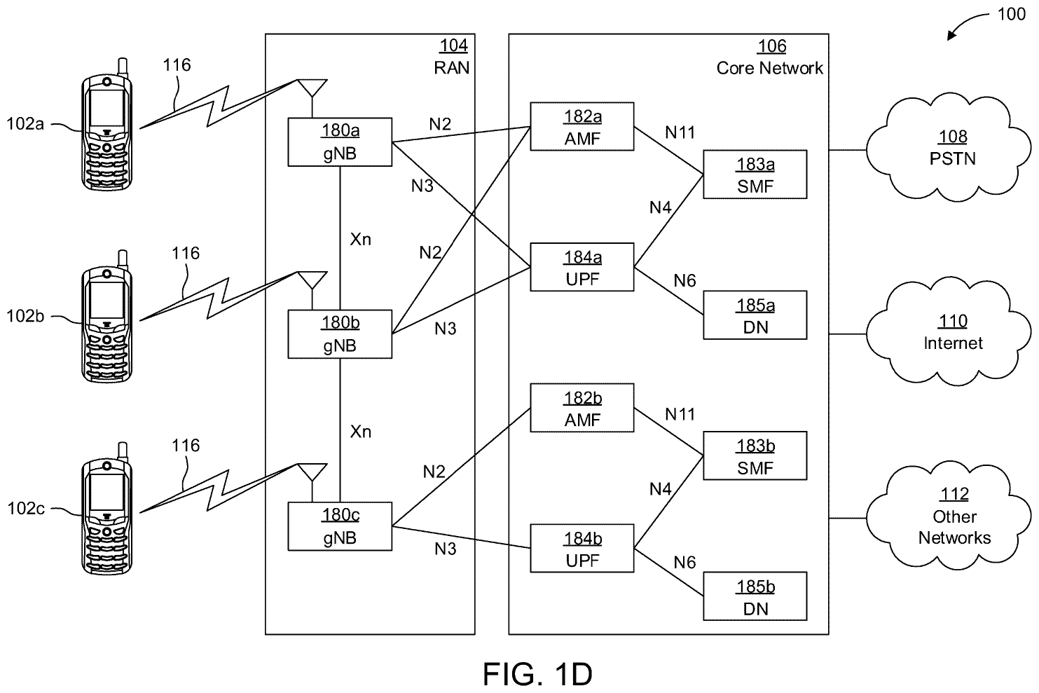

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IOT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

A listing of abbreviations and acronyms as used herein is provided as follows: The acronym “Δf” may refer to a “sub-carrier spacing.” The acronym “gNB” may refer to an “NR NodeB.” The acronym “AP” may refer to “aperiodic.” The acronym “BFR” may refer to “beam failure recovery.” The acronym “BFD-RS” may refer to a “beam failure detection-reference signal.” The acronym “BLER” may refer to a “block error rate.” The acronym “BWP” may refer to a “bandwidth part.” The acronym “CA” may refer to “carrier aggregation.” The acronym “CB” may refer to “contention-based,” such as access, channel, or resource. The acronym “CCA” may refer to a “clear channel assessment.” The acronym “CDM” may refer to “code division multiplexing.” The acronym “CG” may refer to a “cell group.” The acronym “CLI” may refer to “cross-link interference.” The acronym “COMP” may refer to “coordinated multi-point transmission/reception.” The acronym “COT” may refer to “channel occupancy time.” The acronym “CP” may refer to a “cyclic prefix.” The acronym “CPE” may refer to a “common phase error.” The acronym “CP-OFDM” may refer to “conventional OFDM (relying on cyclic prefix).” The acronym “CQI” may refer to a “channel quality indicator.” The acronym “CN” may refer to a “core network,” such as LTE packet core or NR core. The acronym “CRC” may refer to a “cyclic redundancy check.” The acronym “CSI” may refer to “channel state information.” The acronym “CSI-IM” may refer to “channel state information-interference measurement.” The acronym “CSI-RS” may refer to a “channel state information-reference signal.” The acronym “CU” may refer to a “central unit.” The acronym “D2D” may refer to “device-to-device transmissions,” such as LTE Sidelink. The acronym “DC” may refer to “dual connectivity.” The acronym “DCI” may refer to “downlink control information.” The acronym “DL” may refer to “downlink.” The acronym “DM-RS” may refer to a “demodulation reference signal.” The acronym “DRB” may refer to a “data radio bearer.” The acronym “DU” may refer to a “distributed unit.” The acronym “EN-DC” may refer to “E-UTRA-NR dual connectivity.” The acronym “EPC” may refer to an “evolved packet core.” The acronym “DRX” may refer to “discontinuous reception.” The acronym “EPRE” may refer to “energy per resource element.” The acronym “FD-CDM” may refer to “frequency domain-code division multiplexing.” The acronym “FDD” may refer to “frequency division duplexing.” The acronym “FDM” may refer to “frequency division multiplexing.” The acronym “ICI” may refer to “inter-cell interference.” The acronym “ICIC” may refer to “inter-cell interference cancellation.” The acronym “IP” may refer to “Internet Protocol.” The acronym “LBT” may refer to “listen-before-talk.” The acronym “LCH” may refer to a “logical channel.” The acronym “LCID” may refer to a “logical channel identity.” The acronym “LCP” may refer to “logical channel prioritization.” The acronym “LLC” may refer to “low latency communications.” The acronym “LTE” may refer to “Long Term Evolution,” such as from 3GPP LTE R8 and up. The acronym “MAC” may refer to “medium access control.” The acronym “MAC CE” may refer to a “medium access control control element.” The acronym “NACK” may refer to “negative ACK.” The acronym “MBMS” may refer to a “multimedia broadcast multicast system.” The acronym “MCG” may refer to a “master cell group.” The acronym “MCS” may refer to a “modulation and coding scheme.” The acronym “MIMO” may refer to “multiple input multiple output.” The acronym “MPE” may refer to “maximum permissible exposure.” The acronym “MR-DC” may refer to “multi-RAT dual connectivity.” The acronym “MTC” may refer to “machine-type communications.” The acronym “NAS” may refer to “non-access stratum.” The acronym “NCB-RS” may refer to a “new candidate beam-reference signal.” The acronym “NE-DC” may refer to “NR-RAN-E-UTRA dual connectivity.” The acronym “NR” may refer to “new radio.” The acronym “NR-DC” may refer to “dual connectivity.” The acronym “NZP-CSI-RS” may refer to “non-zero-power CSI-RS.” The acronym “OCC” may refer to “orthogonal cover code.” The acronym “OFDM” may refer to “orthogonal frequency-division multiplexing.” The acronym “OOB” may refer to “out-of-band,” as in emissions. The acronym “Pcmax” may refer to “total available WTRU power in a given transmission interval.” The acronym “Pcell” may refer to the “primary cell of a master cell group.” The acronym “PCG” may refer to a “primary cell group.” The acronym “PDU” may refer to a “protocol data unit.” The acronym “PER” may refer to a “packet error rate.” The acronym “PH” may refer to “power-headroom.” The acronym “PHR” may refer to “power-headroom reporting.” The acronym “PHY” may refer to the “physical layer.” The acronym “PLMN” may refer to a “public land mobile network.” The acronym “PLR” may refer to a “packet loss rate.” The acronym “PRACH” may refer to a “physical random-access channel.” The acronym “PRB” may refer to a “physical resource block.” The acronym “PRI” may refer to a “PUCCH resource indicator.” The acronym “PRS” may refer to a “positioning reference signal.” The acronym “Pscell” may refer to the “primary cell of a secondary cell group.” The acronym “PSS” may refer to a “primary synchronization signal.” The acronym “PT-RS” may refer to a “phase tracking-reference signal.” The acronym “QoS” may refer to “quality of service,” from the physical layer perspective. The acronym “RAB” may refer to a “radio access bearer.” The acronym “RAN PA” may refer to a “radio access network paging area.” The acronym “RACH” may refer to a “random access channel” or procedure. The acronym “RAR” may refer to a “random access response.” The acronym “RAT” may refer to “radio access technology.” The acronym “RB” may refer to a “resource block.” The acronym “RCU” may refer to a “radio access network central unit.” The acronym “RF” may refer to a “radio front end.” The acronym “RE” may refer to a “resource element.” The acronym “RLF” may refer to a “radio link failure.” The acronym “RLM” may refer to “radio link monitoring.” The acronym “RNTI” may refer to a “radio network identifier.” The acronym “RO” may refer to a “random access occasion.” The acronym “ROM” may refer to “read-only mode” for MBMS. The acronym “RRC” may refer to “radio resource control.” The acronym “RRM” may refer to “radio resource management.” The acronym “RS” may refer to a “reference signal.” The acronym “RSRP” may refer to “reference signal received power.” The acronym “RSRQ” may refer to “reference signal received quality.” The acronym “RTT” may refer to “round-trip time.” The acronym “SBFD” may refer to “subband non-overlapping full duplex.” The acronym “SCG” may refer to a “secondary cell group.” The acronym “SCMA” may refer to “single carrier multiple access.” The acronym “SCS” may refer to “sub-carrier spacing.” The acronym “SDU” may refer to a “service data unit.” The acronym “SOM” may refer to a “spectrum operation mode.” The acronym “SP” may refer to “semi-persistent.” The acronym “SpCell” may refer to the “primary cell of a master or secondary cell group.” The acronym “SRB” may refer to a “signaling radio bearer.” The acronym “SS” may refer to a “synchronization signal.” The acronym “SRS” may refer to a “sounding reference signal.” The acronym “SSS” may refer to a “secondary synchronization signal.” The acronym “SUL” may refer to a “supplementary uplink.” The acronym “SWG” may refer to a “switching gap” in a self-contained subframe. The acronym “TB” may refer to a “transport block.” The acronym “TBS” may refer to a “transport block size.” The acronym “TCI” may refer to a “transmission configuration index.” The acronym “TDD” may refer to “time-division duplexing.” The acronym “TDM” may refer to “time-division multiplexing.” The acronym “TI” may refer to a “time interval” in integer multiple of one or more symbols. The acronym “TTI” may refer to a “transmission time interval” in integer multiple of one or more symbols. The acronym “TRP” may refer to a “transmission/reception point.” The acronym “TRPG” may refer to a “transmission/reception point group.” The acronym “TRS” may refer to a “tracking reference signal.”

CSI-RS Cross-link interference (CLI) in the context of TDD wireless systems may refer to interference that occurs between uplink (UL) and downlink (DL) transmissions within the same TDD frame or time slot. In TDD systems, the same frequency band may be shared for both UL and DL transmissions, but the transmissions occur in different time slots or frames. This means that UL and DL transmissions may happen within the same frequency resources, but in different time intervals.

Cross-link interference may occur due to various reasons, including imperfect synchronization, imperfect channel estimation, or adjacent channel interference in the case of closely spaced frequency channels, when there might be interference between UL and DL transmissions in neighboring channels. In TDD systems, dynamic power control may be used to adjust the transmit power based on channel conditions. If power control is not optimized, it may lead to interference issues. In addition, antenna crosstalk may also be accounted for in multi-antenna systems.

To mitigate cross-link interference in TDD for 5G, various techniques are employed such as advanced interference cancellation algorithms, adaptive beamforming, dynamic scheduling algorithms, sophisticated power control mechanisms, and advanced antenna designs. These techniques may optimize system performance and enhance spectral efficiency by reducing interference between UL and DL transmissions.

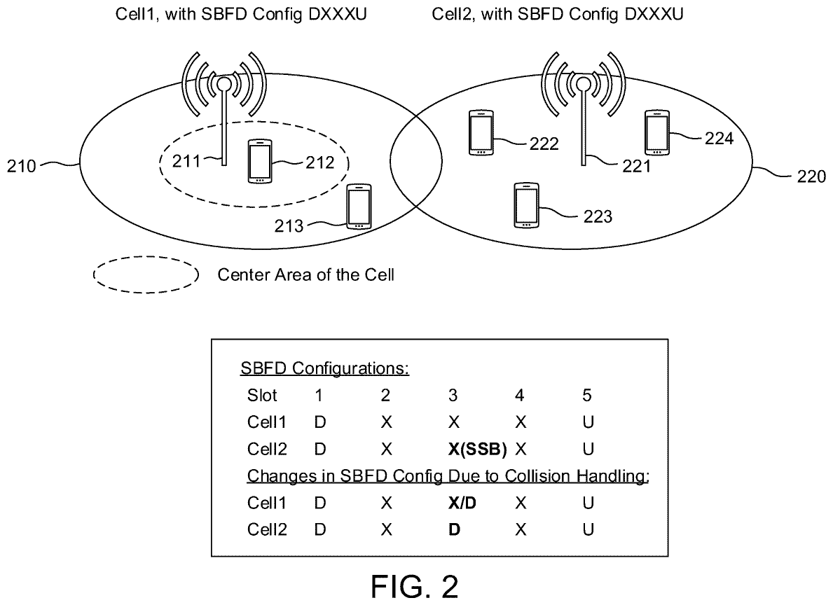

FIG. 2 is a diagram illustrating an example scenario in which cross-link interference may impact SBFD operation. As shown in FIG. 2, WTRUs 212 and 213 are present within a first cell 210. As shown in FIG. 2, WTRU 212 is positioned within a center area of the cell, while WTRU 213 is positioned closer to the cell edge and may be more likely to experience CLI due to its proximity to cell 220. The cell 210 (i.e., in which base station 211 and WTRUs 212 and 213 operate) may be configured (e.g., semi-statically) with resources (e.g., slots as shown in FIG. 2, however, it is understood by those of skill that symbols may be used in other examples) for use in SBFD operation. As shown in FIG. 2, the cell 210 is located adjacent to a second cell 220 in which a base station 221 and WTRUs 222, 223, and 224 are present and/or operate. In cell 220, the base station 221 and WTRUs 222, 223, and 224 may also be configured with resources for use in SBFD operation. In the example shown in FIG. 2, both cells 210 and 220 are configured with a “DXXXU” TDD configuration, where D represents a downlink slot, U represents an uplink slot, and X represents a flexible (e.g., downlink or uplink) slot for SBFD operation.

In the example shown in FIG. 2, base station 221 associated with the second cell 220 may be transmitting SSBs, and one or more SSBs may be transmitted during SBFD symbols and/or slots configured at the first cell 210. The one or more SSBs may be transmitted in one or more DL symbols or slots of the second cell 220. These symbols or slots of the second cell 220 may be configured for SBFD operation in the second cell 220, but may be converted from SBFD to DL symbols or slots due to the presence of an SSB transmission.

In the specific example shown in FIG. 2, the SBFD configurations associated with the first cell 210 and the second cell 220 designate slot 3 as a slot for SBFD operation. However, the base station 221, which is associated with the second cell 220, is scheduled to transmit an SSB transmission in slot 3. As a result, the SBFD configurations (for SBFD-capable WTRUs) associated with one or both of the first cell 210 and the second cell 220 may be changed or updated due to collision handling. As shown, the SSB transmission by base station 221 in slot 3 may result in the conversion of slot 3 to a DL slot for SBFD-capable WTRUs in the second cell 220.

In the scenario illustrated in FIG. 2, where the WTRUs in the first cell may transmit in symbols or slots of the first cell that may overlap symbols or slots in which the WTRUs in the second cell may receive SSBs, the transmissions of the WTRUs in the first cell may cause CLI that affects the reception of SSBs by WTRUs in the second cell. Such CLI may degrade monitoring, detection, reception, and/or measurement of SSBs by WTRUs in the second cell. Thus, for proper collision handling, the SSB transmission in slot 3 by the base station 221 may result in the conversion of slot 3 to a DL slot for SBFD-capable WTRUs in the first cell 210.

A problem addressed by various solutions presented herein may be how to prevent or reduce CLI that is caused by WTRUs transmitting in a first cell. In such cases, CLI may affect WTRUs receiving in a second cell when SBFD symbols and/or slots configured for SBFD in the first cell overlap with symbols and/or slots of the second cell that are configured for DL-only operation, are configured or used for SSB transmission, and/or are converted from SBFD to DL-only symbols or slots, e.g., due to SSB transmissions.

Common terminology used in the description of solutions herein is described below. Hereinafter, ‘a’ and ‘an’ and similar phrases are to be interpreted as ‘one or more’ and ‘at least one’. Similarly, any term that ends with the suffix ‘(s)’ may to be interpreted as ‘one or more’ or ‘at least one’. The term ‘may’ is to be interpreted as ‘may, for example’. A symbol ‘/’ (e.g., forward slash) may be used herein to represent ‘and/or’, where for example, ‘A/B’ may imply ‘A and/or B’.

A beam may correspond to a spatial domain filter or one or more spatial parameters. A beam may correspond to a transmission or receive direction (e.g., spatial direction). A WTRU may transmit or receive a physical channel or reference signal according to at least one beam, spatial domain filter, and/or one or more spatial parameters. The term “beam” may be used to refer to a spatial domain filter a spatial direction, one or more spatial parameters, and/or the like.

The WTRU may send a transmission on a physical channel or may send a signal using the same spatial domain filter as the spatial domain filter used for receiving an RS (such as CSI-RS) or a SS block. The WTRU transmission may be referred to as “target”, and the received RS or SS block may be referred to as “reference” or “source”. In such case, the WTRU may be said to transmit the target physical channel or signal according to a spatial relation with a reference to such RS or SS block.

The WTRU may transmit on a first physical channel or signal according to the same spatial domain filter as the spatial domain filter used for transmitting a second physical channel or signal. The first and second transmissions may be referred to as “target” and “reference” (or “source”), respectively. In such case, the WTRU may be said to transmit on the first (target) physical channel or signal according to a spatial relation with a reference to the second (reference) physical channel or signal.

A spatial relation may be implicit, configured by RRC or signaled by a MAC CE, DCI, or another logical equivalent. For example, a WTRU may implicitly send a PUSCH transmission and a DM-RS of the PUSCH according to the same spatial domain filter as an SRS indicated by an SRI indicated in DCI or configured by RRC signaling, or other logically equivalent signaling. In another example, a spatial relation may be configured by RRC for an SRS resource indicator (SRI) or signaled by MAC CE in a PUCCH transmission. Such spatial relation may also be referred to as a “beam indication”.

The WTRU may receive a first (target) downlink channel or signal according to the same spatial domain filter or spatial reception parameter as a second (reference) downlink channel or signal. For example, such association may exist between a physical channel such as PDCCH or PDSCH and its respective DM-RS. At least when the first and second signals are reference signals, such association may exist when the WTRU is configured with a quasi-colocation (QCL) assumption type D between corresponding antenna ports. Such association may be configured as a TCI (transmission configuration indicator) state. A WTRU may be indicated an association between a CSI-RS or SS block and a DM-RS by an index to a set of TCI states configured by RRC and/or signaled by MAC CE. Such indication may also be referred to as a “beam indication”.

The terms TRP, MTRP, and M-TRP may be interpreted as follows. Hereafter, the term TRP (e.g., transmission and reception point) may be interchangeably used with one or more of the terms TP (transmission point), RP (reception point), RRH (radio remote head), DA (distributed antenna), BS (base station), a sector (of a BS), and a cell (e.g., a geographical cell area served by a BS), but still remain consistent with the example solutions described herein. Hereafter, the term Multi-TRP may be interchangeably used with one or more of the terms MTRP, M-TRP, or multiple TRPs, but still consistent with the example solutions described herein.

The term subband may be interpreted as follows. Hereinafter, the term “subband” and/or “sub-band” may be used to refer to a frequency-domain resource and may be characterized by at least one of the following: a set of resource blocks (RBs); a set of resource block sets (RB sets) such as those used when a carrier has intra-cell guard bands; a set of interlaced resource blocks; a bandwidth part, or portion thereof; or a carrier, or a portion thereof.

For example, a subband may be characterized by a starting RB and number of RBs for a set of contiguous RBs within a bandwidth part. A subband may also be defined by the value of a frequency-domain resource allocation field and bandwidth part index.

Hereinafter, the term “XDD” may be used to refer to a subband-wise duplex operation (e.g., either UL or DL being used per subband) and may be characterized by at least one of the following: Cross Division Duplex (e.g., subband-wise FDD within a TDD band); subband non-overlapping full duplex (SBFD); subband-based full duplex (e.g., full duplex where both UL and DL are used/mixed within a symbol/slot, but either UL or DL being used per subband on the symbol/slot); frequency-domain multiplexing (FDM) of DL/UL transmissions within a TDD spectrum; a full duplex mode other than a same-frequency (e.g., spectrum sharing, subband-wise-overlapped) full duplex mode; or an advanced duplex method, e.g., other than (pure) TDD or FDD.

The term dynamic/flexible TDD may be interpreted as follows. Hereinafter, the term “dynamic (/flexible) TDD” may be used to refer to a TDD system/cell which may dynamically (and/or flexibly) change/adjust/switch a communication direction (e.g., a downlink, an uplink, or a sidelink, etc.) at a time instance (e.g., slot, symbol, subframe, and/or the like). In some examples, in a system employing dynamic/flexible TDD, a component carrier (CC) or a bandwidth part (BWP) may have one single type among ‘D’ (e.g., DL), ‘U’ (e.g., UL), and ‘F’ (e.g., flexible) on a symbol/slot, based on an indication by a group-common (GC)-DCI (e.g., format 2_0) comprising a slot format indicator (SFI), and/or based on tdd-UL-DL-config-common/dedicated configurations. On a given time instance/slot/symbol, a first gNB (e.g., cell, TRP) employing dynamic/flexible TDD may transmit a downlink signal to a first WTRU communicating/associated with the first gNB based on a first SFI and/or tdd-UL-DL-config configured/indicated by the first gNB, and a second gNB (e.g., cell, TRP) employing dynamic/flexible TDD may receive an uplink signal transmitted from a second WTRU communicating/associated with the second gNB based on a second SFI and/or tdd-UL-DL-config configured/indicated by the second gNB. In some examples, the first WTRU may determine that the reception of the downlink signal is being interfered by the uplink signal, where the interference caused by the uplink signal may refer to a WTRU-to-WTRU cross-layer interference (CLI).

An RRC-Connected state is described herein. A WTRU may carry out methods for transitioning between RRC states and/or RRC modes, for example including RRC-Connected state, RRC-Inactive state, and/or RRC-Idle state.

A WTRU may operate in an RRC-Connected state, during which the WTRU may have connected, established an RRC context with, and/or have at least one RRC connection to, for example, one or more cells, base stations, network nodes (e.g., gNBs), TRPs, or other network elements. In an RRC-Connected state, the WTRU may receive RRC context information and/or one or more configuration information at least indicating or including one or more radio bearers, logical channels, PDU sessions, security information, or other types of information. While operating in the RRC-Connected state, the connected WTRU may measure one or more signal quality or signal strength metrics, such as an reference signal received power (RSRP), reference signal received quality (RSRQ), received signal strength indicator (RSSI), or other metrics not listed explicitly. The measurements may be performed on one or more received, detected, configured, and/or indicated reference signals (RSs) associated with (e.g., transmitted from) a serving cell and/or one or more neighboring cells. The connected WTRU may report the measured parameters, for example, to the serving cell.

Cell Discontinuous Reception (DRX) is described herein. Cell DRX may be used, for example in the context of network energy saving, to reduce NW power consumption by allowing the cell (for example, or including, WTRUs operating within the cell) to periodically enter in to a ‘power saving state’ (referred to as DRX inactive, or alternatively as a DRX occasion) during which cell suspends at least reception, for example from the WTRUs. The cell may periodically switch to an ‘active state’ for a limited time (DRX active time) to monitor and receive signals and/or channels (for example, from WTRUs, or other cells). During the ‘active state’, the cell may also be configured to perform one or more dynamic and/or configured UL/DL transmissions and/or receptions. Once determined, scheduled, and/or configured UL/DL data and/or control transmissions and/or receptions are complete, the cell returns to the ‘power saving state’.

Hereafter, the term downlink reception may be used interchangeably with Rx occasion, PDCCH, PDSCH, or SSB reception, but still consistent with solutions described herein.

Hereafter, the term uplink transmission may be used interchangeably with Tx occasion, PUCCH, PUSCH, PRACH, or SRS transmission, but still be consistent with solutions described herein.

Hereinafter, the terms time instance, slot, symbol, and subframe, and frame may all be used interchangeably, but still be consistent with solutions described herein.

Hereinafter, the terms UL-only and DL-only Tx/Rx occasions may be used interchangeably with the terms legacy TDD UL or legacy TDD DL, respectively, and still remain consistent with solutions described herein. In some examples, the legacy TDD UL transmission or legacy DL reception occasions may represent cases where SBFD is not configured and/or where SBFD is disabled.

Hereinafter, the terms received signal power, received signal energy, received signal strength, SSB EPRE, CSI EPRE, RSRP, RSSI, SINR, RSRQ, SS-RSRP, SS-RSSI, SS-SINR, SS-RSRQ, CSI-RSRP, CSI-RSSI, CSI-SINR, and CSI-RSRQ may be used interchangeably, but still remain consistent with solutions described herein.

Hereinafter, the term CLI may be used interchangeably with interference, and still remain consistent with solutions described herein after.

Hereinafter, the term non-SBFD may be understood to be used interchangeably with the phrase ‘operation, transmission, and/or reception without SBFD, TDD, legacy TDD’, and still remain consistent with solutions described herein.

Hereinafter, the terms ‘paired spectrum’ and FDD may be used interchangeably, but still remain consistent

with solutions described herein.

Hereinafter, the terms ‘unpaired spectrum’ and TDD may be used interchangeably, but still remain consistent with solutions described herein.

Hereinafter, the term ‘gNB’, ‘NodeB’, ‘base station’, ‘node’, ‘network node’, or TRP may be referred to interchangeably.

Hereinafter, the phrases ‘WTRU is configured’, ‘WTRU is indicated’, ‘WTRU receives configuration’, and so forth, may be used interchangeably and may also, or alternatively, imply that a configuration or indication is received or indicated, for example, ‘via RRC, MAC-CE, DCI, MIB, SIB, and so forth’, unless indicated otherwise. For example, the phrase ‘WTRU is configured’ may imply the ‘WTRU is configured via RRC, MAC-CE, MIB, SIB, or another logically equivalent message or signal.

Subband non-overlapping full duplex (SBFD) operation is described herein. In some examples, a WTRU may receive configuration information (e.g., from a base station, a gNB, a node, a TRP, or another type of network element) for full-duplex (FD) operation conducted by at least one device in a network. In some examples, the FD operation may be conducted by a network node (e.g., a base station, a node such as a gNB, a TRP, a cell, or another type of network element). The WTRU may operate in a half-duplex (HD) mode for communicating with the network node, where the HD mode may imply that at a given time the WTRU either performs a UL transmission or a DL reception (e.g., not both UL and DL simultaneously at the given time). The WTRU may additionally, or alternatively, operate in an FD mode for communicating with the network node, for example, if a corresponding WTRU capability signal(s) is reported to the network node and/or the WTRU receives a confirmation signal (e.g., enabling the FD, configuring the FD mode) in response to transmitting the WTRU capability signal(s).

FD operation may imply that, at a given time, a transmitter (e.g., the network node and/or the WTRU) may simultaneously transmit a first signal and receive a second signal. FD operation may include subband overlapping FD (e.g., in-band FD (IBFD) operation where a first frequency-domain resource (e.g., RBG(s), RB(s), RE(s)) allocated for the first signal may fully or partially overlap with a second frequency-domain resource allocated for the second signal. FD operation may include the use of subband non-overlapping FD (SBFD) operation where a first frequency-domain resource allocated for the first signal (e.g., assigned within a configured SBFD subband, e.g., DL subband, usable DL PRBs) does not have an overlap with a second frequency-domain resource allocated for the second signal (e.g., assigned within a configured SBFD subband, e.g., UL subband, usable UL PRBs).

Hereafter, for brevity, it should be understood that the term FD operation may refer to SBFD operation; however the solutions and examples in the disclosure may equally (or equivalently or extendedly) be employed or applicable for cases with other FD operation types (e.g., IBFD, etc.).

A WTRU may be configured with one or more types of slots within a bandwidth. A first type of slot may be used or determined for a first direction (e.g., downlink); a second type of slot may be used or determined for a second direction (e.g., uplink). A third type of slot may have a first group of frequency resources within the bandwidth for a first direction and a second group of frequency resources within the bandwidth for a second direction. Hereinafter, the term ‘bandwidth’ may be interchangeably used with the terms bandwidth part (BWP), carrier, subband, or system bandwidth.

The first type of slot (e.g., the slot for a first direction) may be referred to as downlink slot. The second type of slot (e.g., slot for a second direction) may be referred to as an uplink slot. The third type of slot may be referred to as a Sub-Band (non-overlapping) Full Duplex (SBFD) slot. The group of frequency resources for a first direction may be referred to as downlink subband, downlink frequency resource, or as downlink RBs. A group of frequency resources for a second direction may be referred to as uplink subband, uplink frequency resource, or uplink RBs. A group of frequency resources for a flexible direction (e.g., that may be configured for a first direction, second direction, etc.) may be referred to as a flexible subband, flexible frequency resource, or flexible RBs. The group of frequency resources between a first direction and a second direction may be referred to as guard band, guard frequency resource, or guard RBs.

In some examples, a (SBFD-enabled) WTRU may receive or be configured with one or more SBFD UL or DL subbands in one or more DL, UL, and/or flexible TDD time instances (e.g., symbols, slots, frames, and so forth). The WTRU may be configured with one or more resource allocations for SBFD subbands.

For example, the SBFD configuration may include a flag signal (e.g., enabled/disabled), where, for example, a first value of the signal (e.g., zero (0)) may indicate a first mode of operation (e.g., Tx/Rx based on SBFD resource and/or configurations), and a second value (e.g., one (1)) may indicate a second mode of operation (e.g., Tx/Rx based on non-SBFD resources and/or configurations). The Tx/Rx modes of operation (e.g., SBFD or non-SBFD) may be indicated via, for example one or more MIBs, SIBs, RRC messages, MAC-CEs, DCIs, and or other logically equivalent signaling.

Herein, the term “SBFD operation” or “SBFD mode of operation” may indicate WTRU performing Tx/Rx based on SBFD resources and/or configurations. Herein, the term “non-SBFD operation” or “non-SBFD mode of operation” may indicate the WTRU performing Tx/Rx based on non-SBFD resources and/or configurations.

The WTRU may receive an indication of time resources (e.g., one or more symbols, slots, and so forth), for which the first mode of operation (e.g., SBFD) is defined in for example one or more BWPs, subbands, component carriers (CC), cells, and so forth. The WTRU may receive the frequency resources (e.g., subbands, BWPs, etc. including one or more PRBs) within (active and/or linked) BWP, for which the first mode of operation (e.g., SBFD) is configured. The time instances (e.g., slots, symbols) may be indicated based on periodic, semi-persistent, or aperiodic configurations. In some examples, the time instances may be indicated via a bitmap configuration, in which each bit corresponds to a time instance (e.g., slot, symbol, subframe, etc.) and each bit indication may indicate whether oen o more corresponding time instances can be used for the first or second mode of operation.

In some examples, a WTRU may be configured with a DL TDD configuration for a component carrier (CC) or a BWP for one or more Rx occasions (e.g., via tdd-UL-DL-config-common, dedicated configurations, slot format indicator (SFI), and so forth). As such, if the first mode of operation (e.g., SBFD) is configured, one or more of the configured frequency resources (e.g., subbands, PRBs, and/or BWPs) may be configured as the UL channels and/or Tx occasions.

In some examples, the WTRU may be configured with an UL TDD configuration for a component carrier (CC) or a BWP for one or more Tx occasions (e.g., via tdd-UL-DL-config-common, dedicated configurations, slot format indicator (SFI), and so forth). As such, if the first mode of operation (e.g., SBFD) is configured, one or more of the configured frequency resources (e.g., subbands, PRBs, and/or BWPs) may be configured as the DL channels and/or Rx occasions.

In some examples, the WTRU may be configured with a DL, UL, or Flexible TDD configuration for a component carrier (CC) or a BWP for one or more Rx/Tx occasions (e.g., via tdd-UL-DL-config-common, dedicated configurations, slot format indicator (SFI), and so forth). As such, if the first mode of operation (e.g., SBFD) is configured, one or more of the configured frequency resources (e.g., subbands, PRBs, and/or BWPs) may be configured for the first mode of operation (e.g., either UL transmission or DL reception based on the configurations).

The duplexing mode for the first mode of operation (e.g., SBFD configuration (UL/DL)) may be indicated via a flag indication, where, for example, a first value (e.g., zero (0)) may indicate a first direction (e.g., UL duplexing mode), and a second value (e.g., one (1)) may indicate a second direction (e.g., DL duplexing model). The duplexing mode configuration and/or flag for the first mode of operation (e.g., SBFD) may be configured as part of a mode of operation configuration, for example via a MIB, SIB, RRC message, DCI, MAC-CE, or another logically equivalent message. The duplexing mode configuration and/or flag for the first mode of operation (e.g., SBFD) may be configured as part of a resource allocation configuration for a Tx/Rx occasion.

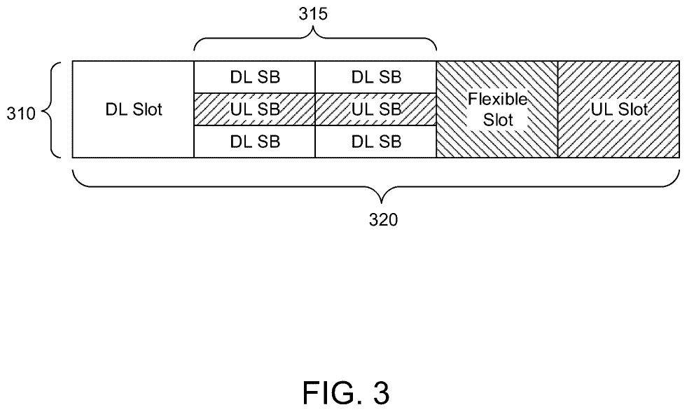

In some examples, the WTRU may be configured with a DUD configuration, in which an UL subband is configured between two DL subbands, as shown by way of example in FIG. 3, introduced and described in further detail in subsequent paragraphs. In some examples, the WTRU may be configured with an UD configuration, where an UL subband is configured with higher frequencies followed by a DL subband with lower frequencies. In another example, the WTRU may be configured with DU configuration, where a DL subband is configured with higher frequencies followed by an UL subband with lower frequencies. These examples should be understood as non-limiting examples of the SBFD configurations and parameters that may be included in SBFD configurations. One or more of those configurations may be included. Other configurations may be included.

In some examples, a WTRU may be configured with one or more types of slots. The WTRU may be configured with a first slot with a first type, where the first type may be, for example, a SBFD slot. The WTRU may be configured with a second slot with a second type, where the second type may be, for example, a non-SBFD slot. As for the first slot with the first type (SBFD), the WTRU may be configured with two or more subbands (e.g., DL, UL, flexible, guard, or other types of subbands) in the frequency domain, throughout the BWP, for the duration of the first slot. However, in the second slot with the second type (non-SBFD), the WTRU may be configured with only one direction type, for example (e.g., DL, UL, flexible, or other type), in the frequency domain, throughout the BWP, for the duration of the second slot.

In some examples, if the WTRU is configured with a second slot with an UL direction, this may indicate that the second slot is a legacy TDD UL slot, a UL-only slot, and/or non-SBFD UL slot. In some examples, if the WTRU is configured with a third slot with a second type (non-SBFD) in the DL direction, this may indicate that this slot is a legacy TDD DL slot, DL-only slot, and/or non-SBFD DL slot. In some examples, if the WTRU is configured with a fourth slot with a second type (non-SBFD) with flexible direction, it may indicate that this slot is a legacy TDD flexible slot and/or non-SBFD flexible slot, and so forth.

FIG. 3 is a diagram illustrating an example structure of SBFD resources. In the example shown in FIG. 3, a TDD cycle may be defined within a time duration 320 that extends over five slots and are allocated within a bandwidth 310. The SBFD resources as shown are defined within two slots 315 that encompasses three subbands. The example configuration shown in FIG. 3 is a downlink-uplink-downlink (DUD) configuration, reflecting the presence of two DL subbands with a single UL subband between them. The SBFD slots are preceded by a DL slot and are followed respectively by a flexible slot and an UL slot.

SBFD time-domain configurations are described in further detail herein. A WTRU may receive configuration information for (e.g., may be configured with) SBFD subband time locations that may be configured within a period. In some examples, the period may be the same as TDD-UL-DL pattern period configured by a parameter such as dl-UL-TransmissionPeriodicity, e.g., in an information element such as TDD-UL-DL-ConfigCommon. In some (e.g., another) examples, the period may be an integer multiple of a TDD-UL-DL pattern period configured by a parameter such as dl-UL-TransmissionPeriodicity, e.g., carried in an information element such as TDD-UL-DL-ConfigCommon.

When a TDD-UL-DL pattern is configured, SBFD symbols may be configured in a consecutive manner within a TDD-UL-DL pattern period. When more than one (e.g., two) TDD-UL-DL patterns are configured, and if SBFD symbols are configured for only one of the patterns, SBFD symbols may be configured in a consecutive manner within the TDD-UL-DL pattern period. When more than one (e.g., two) TDD-UL-DL patterns are configured and if SBFD symbols are configured for both patterns, SBFD symbols may be configured in consecutive manner within each TDD-UL-DL pattern period.

Concepts relating to “usable” PRBs are described herein. A WTRU may determine (or receive an indication, or be configured) that ‘UL usable PRBs’ are a part of UL subband frequency resources within an UL BWP (e.g., an active UL BWP, a currently active UL BWP), and ‘DL usable PRBs’ are a part of DL subband frequency resources within an DL BWP (e.g., an active DL BWP, a currently active DL BWP). The UL usable PRBs may be determined as an intersection between one or more configured or indicated UL subbands and an active UL BWP in SBFD symbols (and/or slots, or another time resource). DL usable PRBs may be determined as an intersection between one or more configured or indicated DL subband(s) and an active DL BWP in SBFD symbols (and/or slots). In some examples, the UL and/or DL usable PRBs may be explicitly configured within active UL and/or DL BWP, e.g., in SBFD symbols and/or slots.

In some examples, a WTRU may receive information indicating a frequency resource allocation for one or more PDSCH or PUSCH transmissions. In some examples the information may include a resource allocation of Type 0, and may include an RBG-level bitmap-based resource assignment. The PDSCH or PUSCH resources may be scheduled or defined within one or more slots, or a different time resource. When an assigned RBG overlaps with a subband boundary, the WTRU may determine that only the PRBs within the DL usable PRBs are valid for PDSCH reception and only the PRBs within UL usable PRBs are valid for PUSCH transmissions. This may imply “partial RBG” assignment is allowed and valid for resource allocation.

In some examples separate CSI reporting configurations for different FD or non-FD symbol types may be used. A WTRU may be configured with two separate CSI report configurations for SBFD and non-SBFD time instances (e.g., symbols, slots, frames, or other time domain resources). In some examples, the WTRU may be configured with a first configuration (e.g., by the parameter CSI-ReportConfig) that may be associated with CSI-RS(s) received and/or measured in (e.g., restricted to) symbols utilized in a first mode of operation and/or configurations (e.g., SBFD). In some examples, the WTRU may be configured with a second configuration (e.g., by the parameter CSI-ReportConfig) that may be associated with CSI-RS(s) received and/or measured in (e.g., restricted to) symbols utilized in a second mode of operation and/or configurations (e.g., non-SBFD).

In some examples, in a first CSI report configurations (e.g., for SBFD operation), for frequency resource allocation for CSI-RS across downlink subbands, the WTRU may use one or more contiguous CSI-RS resource allocation with non-contiguous CSI-RS resources derived by excluding frequency resources outside DL usable PRBs (e.g., configured DL subbands). That is, in the first CSI report configurations, the CSI-RS sequence mapping may be applied to CSI-RS resources within DL usable PRBs only. This may be the same as the case when the CSI-RS sequence mapped to the RBs outside the DL usable PRBs are punctured. In some examples, in a second (CSI report configurations e.g., for non-SBFD operation), for frequency resource allocation, the WTRU may use one or more contiguous CSI-RS resource allocations across an active DL BWP.

In some examples, a WTRU may be configured with a CSI reporting framework. The WTRU may be configured (e.g., via a parameter such as CSI-ReportConfig) for different modes of operation. For example, the modes of operation may be based on FD or non-FD configurations and/or symbol types. Thus, the WTRU may be configured with a first sub-configuration associated with symbols for use in a first mode of operation and/or configuration (e.g., SBFD operation) and a second sub-configuration associated with symbols for use in a second mode of operation and/or configuration (e.g., non-SBFD operation).

CLI measurement is described in further detail herein. A WTRU may be configured, determine, or receive an indication to determine CLI by performing one or more measurements of a Received Signal Strength Indicator (RSSI) in a given time period. The given time period may be one or more slots, OFDM symbols, resource blocks (RBs), resource elements (REs), and/or another time domain resource. The CLI-RSSI that may be measured in a given time and/or frequency resource may be referred to interchangeably as L1-CLI-RSSI, short-term CLI-RSSI, aperiodic CLI-RSSI, CLI, or other terminology. Alternatively, or additionally, the WTRU may be configured, determine, or receive an indication to perform one or more measurements of a Reference Signal Received Power (RSRP) based on one or more reference signals (e.g., SRS-RSRP) to determine CLI in a given time period. The given time period may be one or more slots, OFDM symbols, RBs, REs, and/or another time domain resource. The SRS-RSRP that may be measured in a given time and frequency resource may be referred to interchangeably as L1-SRS-RSRP, short-term SRS-RSRP, aperiodic SRS-RSRP, SRS-RSRP-CLI, or other terminology.

Herein, the terms CLI, CLI-RSSI, L1-CLI-RSSI, and RSSI may be interchangeably used but still consistent with solutions set forth herein. Herein, the terms SRS-RSRP, SRS-RSRP-CLI, L1-SRS-RSRP, and RSRP may be interchangeably used but still consistent with solutions set forth herein.

Layer 1 (L1)/layer 2 (L2) CLI measurements are described herein. When performing measurements, one or more measurement types or metrics (e.g., RSSI or RSRP types) may be used and a WTRU may be configured to measure one or more RSSI (or RSRP) types over different time periods. For example, a first RSSI (or RSRP) type may be based on a measurement taken over a long time period (e.g., more than one slot). The measurement may be reported, for example, via higher layer signaling (e.g., RRC, MAC, or other types of logically equivalent signaling). A second RSSI (or RSRP) type may be based on a measurement taken over a short time period (e.g., a period equal to one slot, a period within a slot, and/or one or more OFDM symbols within a slot). The measurement may be reported, for example, via L1 signaling (e.g., a transmission on a PUCCH, PUSCH, RACH, SRS, or other logically equivalent channels). In the foregoing description, RSSI may be interchangeably used with RSRP, RSRQ, SINR, or other metrics. In the foregoing description, CLI-RSSI may be interchangeably used with SRS-RSRP and SINR.

Time and frequency resources for measurements are described in greater detail herein. The WTRU may be configured with a set of time and frequency resources for performing measurements (e.g., to measure L1-CLI-RSSI). the time and frequency resources for such measurements (e.g., L1-CLI-RSSI) may be referred to as CLI-RSSI Measurement Resource (CRMR).

A CRMR may be a resource configured, determined, or defined (e.g., via RRC, MAC-CE, DCI or other logically equivalent signaling. For example, such resources may be configured via information elements such as CLI-ResourceConfig, CLI-ResourceConfig-r-16, or by other elements or parameters. The CRMR may have one or more properties as described in the following paragraphs.

A CRMR may include a set of muted REs in a downlink resource (e.g., PDSCH). The muted REs may be rate-matched around or punctured for downlink reception and/or uplink transmission. The set of muted REs may have a same pattern (e.g., same time and frequency location) in each RB. The set of muted REs may have a different pattern based on the RB location. For example, a first pattern may be used for the RBs located in an edge of the scheduled RBs and a second pattern may be used for the RBs located in a center of the scheduled RBs. The first pattern and the second pattern may have a different number of muted RES. The muted REs may be in a form of zero-power resources (e.g., CSI-RS and/or ZP-CSI-RS).

A CRMR may include set of REs not scheduled or used for the WTRU measuring the CRMR.

A CRMR may include a set of REs that may be located in an RB which may be configured or determined as guard band (or guard RB). A guard band (or guard RB) may be located in between uplink and downlink resources. A WTRU may skip receiving or transmitting a signal in guard band.

One or more reference signals (e.g., DMRS, SRS, sidelink CSI-RS, etc.) may be transmitted in the CRMR.

A CRMR may include different CDM groups. For example, the CRMR may include a second set of DMRS REs within a second CDM group (e.g., within a scheduled downlink resource and/or RBs, e.g., of PDSCH). A WTRU may receive control information (e.g., DCI) scheduling the PDSCH, indicating a first set of DMRS REs corresponding to a first CDM group to be used for receiving the PDSCH. In some examples, the WTRU may receive DCI scheduling the PDSCH, indicating a first set of DMRS REs corresponding to a first CDM group. The indication of the first set of DMRS REs corresponding to the first CDM group may be an indicated (DMRS) ‘antenna port’ field in the DCI. In response to receiving the DCI, the WTRU may determine that a second set of DMRS REs within the second CDM group (or some CDM group other than the first CDM group) may be used as the CRMR, for example, within the scheduled PDSCH.

A CRMR may be located within a scheduled resource (e.g., scheduled PDSCH RBs)

A CRMR may be configured commonly for a set of WTRUs (e.g., WTRUs in proximity). For example, a gNB may configure a CRMR for a group of WTRUs. The group of WTRUs may share one or more characteristics as described in the following paragraph.

The group of WTRUs may share a group-ID, which may be used to receive and/or transmit control information such as DCI. For example, the group of WTRUs may share a group-RNTI. The group of WTRUs may share a zone-ID. The zone-ID may be determined based on a geographical location of the WTRU (e.g., determined through GNSS positioning). The group of WTRUs may include one or more WTRUs that are paired for sidelink unicast (or groupcast) transmission.

In some examples, a L1-CLI-RSSI measurement (including CRMR resource) may be considered as CSI reporting quantity and configured as a part of CSI reporting setting.

In some examples, a CRMR may be configured in one or more subbands of a first type (e.g., one or more DL subbands) to enable measurements of the effect of one or more reference signals received in one or more subbands of a second type (e.g., one or more UL subbands). As such, the reference signals may be received and measured in resources that can be identified as zero-power or muted resources. The WTRU may be configured, may determine, or may receive an indication to measure the effect of reference signals being transmitted in one set of resources (e.g., resources of a second type, e.g., UL subbands) on another set of resources (e.g., resources resource of a first type, e.g., DL subbands). For example, a first WTRU may be configured to measure SRS-RSRP in one or more DL subbands on an SBFD configuration, while the SRS is transmitted (e.g., by a second WTRU) in one or more UL subbands. In some examples, the first WTRU may measure the SRS-RSRP based of the configured SRS signaling in the DL subbands. In other examples, the WTRU may measure the CLI-RSSI based on the configured SRS signaling in the UL subbands.

Measurements of delta-CLI are described herein. The WTRU may be configured, may determine, or may receive an indication to determine a delta CLI-RSSI, which may be based on a first CLI-RSSI measurement in a first time and/or frequency location and a second CLI-RSSI measurement in a second time and/or frequency location. One or more details described in the following paragraphs may apply.

The delta CLI-RSSI (delta-CLI-RSSI) may be a difference between a first CLI-RSSI (e.g., CLI-RSSI₁) and a second CLI-RSSI (e.g., CLI-RSSI₂). For example: delta-CLI-RSSI=CLI-RSSI₁−CL-RSSI₂, or delta-CLI-RSSI =CLI-RSSI₂−CL-RSSI_{1,}.

A first CLI-RSSI may be measured from CRMR resources located in the edge of the scheduled RBs while a second CLI-RSSI may be measured from CRMR resources located in the middle of the scheduled RBs.

A WTRU may be configured with a first CRMR resource for the first CLI-RSSI measurement and a second CRMR resource for the second CLI-RSSI measurement.

A WTRU may determine to report CLI measurement related information when a measured delta-CLI-RSSI is larger than a threshold. For example, CLI reporting may be triggered based on a delta-CLI-RSSI measurement being greater than a threshold, wherein the threshold may be predetermined or configured.

Bandwidth and/or subband configurations for CLI measurement are described herein. A WTRU may be configured or may determine to measure CLI-RSSI per subband level. In some examples, a subband may be configured, or predetermined and a WTRU may perform CLI-RSSI measurements in each subband. In some examples, a subband size may be determined based on a number of scheduled RBs (e.g., for PDSCH). In some examples, a WTRU may report CLI-RSSI measurements for some or all subbands. In some examples, the WTRU may report all of or a subset of CLI-RSSI measurements. In some examples, a subset of measurements may be determined or reported based on one or more conditions. In some examples, measurements may be reported for CLI-RSSI values above a threshold, for certain subband locations (e.g., edge of scheduled RBs), and/or certain subband indexes.

A WTRU may determine a bandwidth for beam measurement and/or reporting (e.g., wideband or subband) based on one or more characteristics. One characteristic may be a time unit type (e.g., SBFD or non-SBFD). For example, a WTRU may report wideband CRI (e.g., wideband beam index) in non-SBFD time units (e.g., symbol, slot, and so forth) and the WTRU may report subband CRI (e.g., subband beam index) in SBFD time units.

A WTRU may determine a bandwidth (e.g., wideband or subband) for beam measurement and/or reporting based on the presence of a CLI-RSSI measurement. For example, a bandwidth for beam measurement/reporting may be determined based on whether CLI-RSSI is measured in the same slot or not.

The WTRU may be configured or may receive an indication to perform CLI-RSSI measurements in one or more specific frequency locations within scheduled RBs (or non-scheduled RBs). The specific frequency location(s) may be located within one or more subbands, RBs, and/or REs. In some examples, the indication may be included in control information such as DCI, which may trigger the CLI-RSSI measurement (e.g., an aperiodic CLI-RSSI measurement). In some examples, the specific frequency location may be indicated based on the CRMR resource frequency location. In some examples, one or more CRMR resources may be configured and each CRMR resource may be located in a specific frequency location based on the configuration. The WTRU may receive an indication to perform one or more measurements on a CRMR resource indicated by a DCI.

SRS types are described herein. A WTRU may be configured or may receive an indication to transmit one or more SRSs. A particular SRS resource within one or more SRSs may be configured for a particular purpose. Such purposes may include beam management, channel acquisition (e.g., based on channel reciprocity), link adaptation, antenna switching, for example. The aforementioned particular purpose may be interpreted to be specific to a communication link between the WTRU and a network node (e.g., a serving node (e.g., gNB), base station, cell, or TRP associated with the WTRU or a target node (e.g., gNB), base station, cell, or TRP to which the WTRU may switch). For example, a first SRS type may denote an SRS configured for one of the aforementioned purposes and/or for the communication link between the WTRU and the network node. It should be understood that the first SRS type is a non-limiting example of a type of SRS that may be used for or to support a communication link between the WTRU and its serving cell, TRP, base station, and/or node.

The WTRU may be configured or may receive an indication to transmit using a second one or more SRS resources, to support CLI measurements by a receiving device. The second one or more SRS resources may be denoted by a second SRS type (e.g., CLI-SRS). The second SRS type may be understood as another non-limiting example of a type of SRS that may be used for or to support at least the CLI measurements at a receiver side (e.g., other WTRU(s), network nodes (e.g., gNB(s)) base stations, TRPs, or other communication devices and/or nodes in the network). Other types of transmissions may be substituted for the above-referenced transmission performed based on the second SRS type and still remain consistent with the solutions described herein.

CLI measurements performed at the receiver side (e.g., at a WTRU) may include one or more of: an energy-level or power-level measurement (e.g., CLI-RSSI) performed on a configured or indicated DL resource (e.g., a form of zero-power resource, a configured CLI-measurement resource, or another type of resource), a sequence-based and/or correlation-based RS power measurement (e.g., SRS-RSRP) on a configured or indicated RS sequence and/or resource (e.g., SRS resource which may be transmitted from the WTRU causing the CLI to the second WTRU), an SINR or CQI type of channel quality metric derivation to be reported, or another type of measurement.

Solutions for determining whether to carry out FD or non-FD operation are described herein. Some solutions may involve the consideration of SSBs with PCIDs. Configurations specific to serving and/or neighbor cells may be necessary to enable such determination.

Configurations associated with a serving cell are described herein. A WTRU may be configured with and/or receive configuration information for a first and a second mode of operation, which may involve transmission and/or reception for example in the serving cell. For example, the WTRU may receive configuration information via a MIB, SIB, RRC, MAC-CE, DCI, or another type of logically equivalent signaling. In some examples, a first mode of operation may refer to an SBFD mode of operation, in which the WTRU may be configured with one or more resources in which to apply and/or use one or more configured first sets of configurations (e.g., SBFD configurations). For example, the WTRU may be configured with time and frequency resources for SBFD operation, for example, for use within a TDD cycle. In some examples, the WTRU may be configured with one or more of the following: at least one UL subband, at least one DL subband, one or more guard bands, one or more threshold and offset values, configurations relating to random access occasions, frequency hopping configurations, one or more TCI states, beam directions. In some examples, a second mode of operation may refer to a non-SBFD mode of operation. For a non-SBFD mode of operation, the WTRU may be configured with time and frequency resources in which the WTRU may apply and/or use one or more configured second sets of (e.g., non-SBFD) configurations.

Configurations associated with neighbor cells are described herein. In some solutions, a WTRU may receive, determine, be configured with, and/or receive an indication of one or more neighbor cells (also referred to herein as adjacent cells). The WTRU may receive, determine, be configured, and/or indicated with the time and frequency locations of one or more SSBs and/or SSB bursts associated with one or more of the neighbor cells. For example, the WTRU may receive the time, frequency, and/or periodicity of SSB bursts that are or will be transmitted in one or more neighbor cells. In some examples, the WTRU may be configured with up to X (e.g., X=3) neighbor cells, where the WTRU may be configured with a respective physical cell-ID (PCID) for each of the X neighbor cells. The PCID(s) that may (also) be configured for inter-cell beam management, multi-TRP operation, or other purposes. In response to receiving the indicated or configured X PCIDs (or information relating to the X cells), the WTRU may determine that at least one parameter related to an FD (e.g., SBFD) operation or mode for the serving cell is changed, switched, or updated to a second parameter or value. The change, switch, or updating of the at least one parameter may be based on a rule for link direction management across multiple cells (e.g., including the serving cell and X cells). The parameter may be (or may provide) a symbol type determination. The parameter may indicate a symbol type is an FD (e.g., SBFD) symbol type, for example, if no overlap with RS transmission(s) from X cell(s). The parameter may indicate a symbol type is a non-FD (e.g., non-SBFD) symbol type, for example, if there is at least partial overlap with RS transmission(s) from the X cell(s).

An example scenario in which at least partial overlap between RS transmissions among neighbor cells is illustrated in FIG. 2, introduced and described in detail in paragraphs above. For example, FIG. 2 portrays a first cell 210 and a second cell 220 that overlap in coverage with each other and may therefore be prone to have overlapping RS transmissions.

In some solutions, the WTRU may receive FD configurations regarding one or more of the configured neighbor and/or adjacent cells. In some examples, the WTRU may receive configuration information and/or one or more indications regarding Tx/Rx capabilities with respect to configured SBFD resources and/or configurations regarding the configured neighbor cells. For example, a received indication may indicate whether a corresponding neighbor cell supports FD transmission and/or reception (e.g., SBFD) or not. In addition, the received configurations may include or may indicate the time and frequency resources, UL and DL subbands, guard bands, and other parameters regarding FD (e.g., SBFD) resources and/or configurations in corresponding neighbor cells.

In some examples, the WTRU may receive the configuration information and/or one or more indications regarding neighbor cells' SSB and/or SBFD configurations. This configuration information may be received as part of a PBCH, MIB, and/or SIB transmission, which may be received by monitoring, detecting, and/or receiving one or more SSBs from the corresponding neighbor cells. In some examples, the WTRU may receive the corresponding configuration information and/or indications regarding the neighbor cells via RRC, MAC-CE, DCI, or other logically equivalent signaling that is received, for example, from the serving cell.

Solutions for determining target symbols associated with a service cell are described herein. In some solutions, a WTRU may determine, be configured with, and/or receive an indication of a first one or more symbols (referred to interchangeably as “target” symbols, for brevity). In some examples, the target symbols may coincide and/or overlap in time with a second one or more (e.g., specially) indicated and/or configured symbols from a neighbor cell (e.g., a first neighbor cell among an indicated or configured group of X cells).

In some examples, the target symbols may be indicated by or configured along with one or more configurations (e.g., SBFD configurations), based on which the target symbols may at least include an UL subband and a DL subband. The WTRU may be configured and/or enabled to determine a mode of operation in one or more target symbols.

In some examples, the WTRU may determine and/or receive configuration information and/or indications for determining the target symbols. One or more of the following examples may apply:

In an example, the WTRU may determine the presence of target symbols (or, in other words, the status of a symbol as a target symbol) based on the symbols that coincide with one or more time instances in the first neighbor cell, during which one or more configured and/or indicated DL transmissions are scheduled or are transmitted. In some examples, the indicated and/or configured DL transmission may be an SSB, CSI-RS, TRS, DMRS, though other types of DL transmissions may be considered.

In some examples, the WTRU may determine the target symbols based on the symbols that coincide with one or more time instances in the first neighbor cell, during which the FD configuration may be changed, for example from a first mode of operation to a second mode of operation. For example, the first mode of operation may be Tx/Rx based on SBFD resources and/or configurations, and the second mode of operation may be Tx/Rx based on non-SBFD resources and/or configurations.

In some examples, the WTRU may receive configuration information and/or one or more indications that a target symbol coincides with a first symbol that may be considered a non-SBFD symbol, a DL-only symbol, and/or an UL-only symbol in the first neighbor cell. The WTRU may receive or determine such configuration information or indications based on one or more information described in the following paragraphs.

The WTRU may receive or determine configuration information or indications, based on an explicit indication, that concern the coincidence of a target symbol with a first symbol that may be considered a non-SBFD symbol, a DL-only symbol, and/or UL-only symbol in the first neighbor cell. For example, the WTRU may receive one or more indications for one or more first symbols in the first neighbor cell that may be configured for operation in the second mode of operation (e.g., SBFD DL-only). In some examples, the WTRU may receive one or more explicit indications indicating that one or more first symbols configured for use in the first mode of operation (e.g., for Tx/Rx based on SBFD resources and/or configurations) in the first neighbor cell should be considered as symbols for use in the second mode of operation (e.g., Tx/Rx based on non-SBFD and/or DL-only resources and/or configurations). The indications may, in effect, indicate that the one or more symbols should be treated as, changed, switched, updated, reverted to, applicable for, or exceptionally applicable for use in the second mode of operation. In some examples, the WTRU may receive the indication via RRC, MAC-CE, DCI, or via other logically equivalent signaling.

In some examples, the indication may indicate one or more time instances. For example, the WTRU may receive a starting time, a time duration, and/or an end timing, during which the first symbols may be considered symbols for use in the second mode of operation.

In some examples, the indication may indicate one or more frequency resources. For example, the WTRU may receive a starting frequency, a frequency length, and/or a last frequency, for which the first symbols may be considered as symbols the with second mode of operation.

In some examples, the indication may indicate a mode of operation. For example, the WTRU may receive one or more indications concerning the second mode of operation, for example and indication that transmission or reception is to be performed based on non-SBFD resources and/or configurations.

In some examples, the indication may indicate an UL or DL direction. For example, the WTRU may receive one or more indications on the direction to be considered in the first symbols, during the time where the operation in the first symbol may be used for the second mode of operation. In an example, the WTRU may receive one or more indications that the first symbol may be considered a DL-only symbol or an UL-only symbol.

In some solutions, the WTRU may receive or determine configuration information or indications, based on an implicit indication, that concern the coincidence of a target symbol with a first symbol that may be considered a non-SBFD symbol, a DL-only symbol, and/or UL-only symbol in the first neighbor cell. For example, the WTRU may implicitly determine that the first symbol should be considered (e.g., should be treated as, changed, switched, updated, reverted, be applicable, or be exceptionally applicable) for use in second mode of operation (e.g., a non-SBFD mode of operation). The implicit determination may be made base on RS transmission(s) from configured X cell(s), based on one or more conditions, statuses, indications, or other conditions. One or more of the conditions described in the following paragraphs may apply.

In some solutions, the WTRU may receive or determine configuration information or indications, based on a transmission such as an SSB transmission or another type of reference signal transmission, that concern the coincidence of a target symbol with a first symbol that may be considered a non-SBFD symbol, a DL-only symbol, and/or UL-only symbol in the first neighbor cell. For example, the WTRU may receive timing information indicating the time domain locations of SSB transmissions. As such, the WTRU may determine that first symbols coinciding with an SSB transmission may be considered (i.e., should be treated as, changed, switched, updated, reverted to, applicable for, or exceptionally applicable for use) as non-SBFD DL-only symbols in the neighbor cell.

In some solutions, the WTRU may receive or determine configuration information or indications, based on the configuration of a cell for DRX and/or DTX procedures, that concern the coincidence of a target symbol with a first symbol that may be considered a non-SBFD symbol, a DL-only symbol, and/or UL-only symbol in the first neighbor cell. For example, the WTRU may receive configuration information indicating or associated with time domain locations where cell DRX, for example in Network Energy Saving (NES) framework context, may be configured. As such, the WTRU may determine that these symbols may be considered as non-SBFD DL-only symbols in the neighbor cell.

Measurements associated with serving and/or neighbor cells are further described herein. In some solutions a WTRU may determine, be configured, and/or receive an indication to measure one or more quality and/or interference parameters associated with a first neighbor cell. The WTRU may determine, be configured, and/or receive an indication to measure such quality and/or interference parameters based on signals in one or more target symbols. In some examples, the WTRU may measure one or more quality parameters, such as an RSRP, RSSI, RSRQ, CQI, or another quality metric. based on one or more SSBs, RSs, or other signals. from the first neighbor cell. In some examples, the WTRU may measure one or more interference parameters, such as SINR, SRS-RSRP, CLI-RSSI, or another interference parameter, based on one or more SSBs, RSs, or other signals from the first neighbor cell. The WTRU may receive configuration information and/or indications to measure the quality parameters via RRC, MAC-CE, DCI, or other logically equivalent signaling. The configuration information may include corresponding SSB indexes, CSI-RS resources, CSI-RS resource sets, or other parameters.

In some examples, the WTRU may measure one or more quality parameters based on one or more received signals associated with the serving cell, for example RSRP, RSSI, RSRQ, CQI, SINR, etc. For example, the WTRU may use one or more RSs, SSBs, etc. for measuring one or more quality parameters associated with the serving cell.

Conditions for FD or non-FD operation, including conditions based on a neighbor cell's configuration, are described herein. In some solutions, a WTRU may be configured and/or receive one or more indications to determine a mode of operation in one or more determined, configured, and/or indicated symbols (e.g., target symbols). The WTRU may be configured to determine the mode of operation based on one or more measurements, conditions, threshold values, or other parameters. The measurements may be based on one or more measured reference signals from the serving cell and/or one or more of the configured neighbor cells. For example, the WTRU may receive configuration information and/or one or more indications as to whether such determinations as to the mode of operation for one or more target symbols are enabled or disabled at the WTRU.

For example, a first mode of operation may be based on a Tx/Rx status of a symbol according to configured FD (e.g., SBFD) resources and/or configurations. In some examples, the second mode of operation may be used based on a Tx/Rx status of a symbol, which may be determined according to configured non-FD (e.g., non-SBFD) resources and/or configurations. In some examples, the WTRU may change a mode of operation in a target symbol if the target symbol is configured, indicated, and/or determined for use in the first mode of operation. In some examples, the WTRU may receive one or more threshold values and/or corresponding configuration information via RRC, MAC-CE, DCI, or other logically equivalent signals.

Default modes of operation in target symbols are described herein. In some examples, the WTRU may be configured, preconfigured (e.g., by default), and/or receive one or more indications or predications to switch to the second mode of operation for a target symbol. In some examples, such as in cases where the WTRU does not receive an indication enabling the WTRU to determine the mode of operation in one or more target symbols, the WTRU may determine the mode of operation to be (e.g., by default) the second mode of operation. That is, the WTRU may be configured and/or indicated (e.g., by default) to not operate based on the configured resources and/or configurations using the first mode of operation in one or more target symbols.

Conditional determinations as to the mode of operation in target symbols are further described herein. In some examples, a WTRU that may be configured to use a first mode of operation for one or more target symbols (e.g., a WTRU configured with SBFD resources and/or configurations), may determine the mode of operation for the corresponding target symbols between the first and the second modes of operation, based on one or more conditions. For example, a WTRU that may be configured and/or scheduled to transmit an UL transmission in one or more UL subbands of the target symbol may, based on configured SBFD resources and/or configurations, determine whether to transmit or not transmit the determined, configured, and/or indicated UL transmission. That is, the WTRU may determine whether to use or not to use the configured UL subband in the target symbols based on configured SBFD resources and/or configurations.

In some examples, a WTRU that has determined to not transmit the scheduled, determined, configured, and/or indicated UL transmission in one or more UL subbands of the target symbol (e.g., based on configured SBFD resources and/or configurations, such as is described above) may indicate and/or report the determination or decision to refrain from sending the UL transmission. The WTRU may send or report the indication, for example, to a base station, a node such as a gNB, a TRP, or another network element. In some examples, the WTRU may send an indication (e.g., via a flag indication) as part of a CSI-RS report, a specific SR, HARQ-ACK, in a subsequent (e.g., immediately subsequent, or later) configured, determined, and/or scheduled UL transmission. In some examples, the transmitted report and/or indication may include information indicating the condition based on which the WTRU did not transmit the UL transmission. A WTRU may determine a mode of operation in one or more target symbols based on one or more conditions, such as those set forth in paragraphs below.

A WTRU may determine a mode of operation in one or more target symbols based on a measured received power. For example, the WTRU may determine the mode of operation based on a measured received power (e.g., RSRP) that may be measured based on the serving cell and/or at least the first neighbor cell, as described herein.

In some examples, the WTRU may determine, be configured, and/or receive an indication to use the first mode of operation (e.g., UL transmission using UL subband based on configured SBFD resources and/or configurations) in the target symbols if the measured received power of a signal associated with the serving cell is higher than a configured first (e.g., RSRP) threshold. By way of illustration in FIG. 2, WTRU 212 is positioned close to the center of the first cell 210 and is positioned farther from the second cell 220. Due to its proximity to the base station 211, a higher measured power of a signal received from the base station 211 may be expected at WTRU 212. If the measured power exceeds a threshold, the WTRU 212 may be configured to use the first mode of operation (i.e., SBFD operation).

In some examples, the WTRU may determine, be configured, and/or receive an indication to operate in the second mode of operation (e.g., the WTRU does not transmitting a configured, determined, and/or scheduled transmission in an UL subband, according to SBFD resources and/or configurations) in the target symbols if a measured received power of a signal associated with the first neighbor cell is higher than a configured second (e.g., RSRP) threshold. By way of further illustration in FIG. 2, WTRU 213 is positioned farther from the center of the first cell 210 than WTRU 212 but closer to the second cell 220. Due to the lesser distance between the base station 221 and the WTRU 213, a higher measured power of a signal received from the base station 221 may be expected at WTRU 213. If the measured power of a signal received from the base station 221 exceeds a threshold, the WTRU 212 may be configured to use the second mode of operation (i.e., non-SBFD operation).

In some examples, a WTRU may determine, be configured, and/or receive an indication to operate in the second mode of operation (e.g., the WTRU may not transmit a configured, determined, and/or scheduled transmission in the UL subband, according to SBFD resources and/or configurations) in the target symbols if a measured received power of a signal associated with the first neighbor cell is higher than a configured third (e.g., RSRP) threshold and the measured received power of a signal associated with the serving cell is lower than the configured first (e.g., RSRP) threshold.

In some examples, the WTRU may determine, be configured, and/or receive an indication to operate in the first mode of operation (e.g., the WTRU may transmit a configured, determined, and/or scheduled transmission using an UL subband, based on configured SBFD resources and/or configurations) in the target symbols if a measured received power of a signal associated with a first neighbor cell is lower than a configured third (e.g., RSRP) threshold and the measured received power of a signal associated with the serving cell is lower than the configured first (e.g., RSRP) threshold.

In some examples, the WTRU may determine, be configured, and/or receive an indication to operate in the first mode of operation (e.g., the WTRU may transmit a configured, determined, and/or scheduled transmission using an UL subband, based on configured SBFD resources and/or configurations) in the target symbols if a measured received power of a signal associated with the first neighbor cell is lower than a configured fourth (e.g., RSRP) threshold.

In some examples, the configured first, second, third, and/or fourth (RSRP) threshold values may be the same or different from each other.

A WTRU may determine a mode of operation in one or more target symbols based on a measured CLI associated with a first neighbor cell. For example, the WTRU may determine the mode of operation based on the measured CLI (e.g., CLI-RSSI, SRS-RSRP, etc.) that may be measured based on CLI resulting from transmissions associated with the first neighbor cell, as described herein.

In some examples, the WTRU may determine, be configured, and/or receive an indication to operate in the first mode of operation (e.g., UL transmission using UL subband based on configured SBFD resources and/or configurations) in the target symbols if the measured received CLI power and/or strength associated with the first neighbor cell is lower than a configured (e.g., CLI) threshold.

In some examples, the WTRU may determine, be configured, and/or receive an indication to operate in the second mode of operation (e.g., not transmitting a configured, determined, and/or scheduled transmission in the UL subband, according to SBFD resources and/or configurations) in the target symbols if the measured received CLI power and/or strength associated with the first neighbor cell is higher than the configured threshold (e.g., CLI threshold).

A WTRU may determine a mode of operation in one or more target symbols based on a frequency gap between DL frequency resources (e.g., REs, RBs, etc.) in the neighbor cell and UL frequency resources in the target symbols. In some examples, the WTRU may determine a first set of frequency resources (e.g., one or more REs, RBs, or other frequency domain resources), including the start frequency, the end frequency, and/or the frequency range, used for the configured DL transmission in the first symbol in the first neighbor cell, where the DL transmission may include an SSB, CSI-RS, TRS, DMRS, or other types of signals. In some examples, the WTRU may determine a second set of frequency resources (e.g., one or more REs, RBs, or other frequency domain resources), including the start frequency, the end frequency, the frequency range, that are used for the configured, scheduled, and/or determined UL transmission in the target symbol. It should be understood that the first “set” of frequency resources and the second “set” of frequency resources may refer to one frequency domain resource or to multiple frequency domain resources.

In some examples, the WTRU may determine the frequency gap between the first and second sets of frequency resources. For example, if the first set and the second set of frequency resources partially or totally overlap, the WTRU may consider and/or determine the frequency gap to be zero. In some examples, if the first set and second set of frequency resources do not overlap, and if the first set of frequency resources have higher frequencies compared to the second set of frequency resources, the WTRU may determine the frequency gap by for example subtracting the highest frequency of the second frequency resources from the lowest frequency of the first frequency resources. The result may be used as the frequency gap. In some examples, if the first and second set of frequency resources do not overlap, and if the first set of frequency resources have lower frequencies compared to the second set of frequency resources, the WTRU may determine the frequency gap by for example subtracting the highest frequency of the first set of frequency resources from the lowest frequency of the second set of frequency resources (e.g., REs, RBs, etc.). The result may be used as the frequency gap. The WTRU may determine the frequency gap based on frequency units (KHz, THz, etc.) and/or a number of REs, RBs, or another type of frequency domain resource.

The WTRU may determine a mode of operation based on a determined distance and/or frequency gap between the first and second sets of frequency resources. In some examples, the WTRU may be configured and/or receive an indication (e.g., an enable/disable flag indication) that the WTRU may determine the mode of operation based on the determined distance and/or frequency gap, regardless of the measured RSRP and/or CLI.

In some examples, the WTRU may determine, be configured, and/or receive an indication to operate in the first mode of operation (e.g., perform an UL transmission using an UL subband, based on configured SBFD resources and/or configurations) in the target symbols if the determined frequency gap is larger than a configured threshold, which may be expressed in terms of a frequency, RE, RB, or other frequency domain resource.

In some examples, the WTRU may determine, be configured, and/or receive an indication to operate in on the second mode of operation (e.g., not transmit a configured, determined, and/or scheduled transmission in the UL subband, according to SBFD resources and/or configurations) in the target symbols if the determined frequency gap is lower than the configured threshold, which may be expressed in terms of a frequency, RE, RB, or other frequency domain resource.

The WTRU may determine a mode of operation based on a priority of a determined, scheduled, and/or configured UL transmission. For example, the WTRU may determine the mode of operation based on the type or priority of determined, scheduled, and/or configured UL transmission.

In some examples, the WTRU may determine, be configured, and/or receive an indication to operate in the first mode of operation (e.g., perform an UL transmission using an UL subband based on configured SBFD resources and/or configurations) in the target symbols if the UL transmission scheduled by a grant (e.g., a dynamic grant) indicated (e.g., in an associated DCI) has a first (e.g., high) priority level.

In some examples, the WTRU may determine, be configured, and/or receive an indication to operate in the second mode of operation (e.g., not transmitting configured, determined, and/or scheduled in the UL subband and according to SBFD resources and/or configurations) in the target symbols if an UL transmission scheduled by a grant (e.g., a dynamic grant indicated, for example, in an associated DCI) has a second (e.g., low or lower) priority level.

In some examples, the WTRU may be configured and/or receive an indication (e.g., via an enable/disable flag indication) that the WTRU may determine the mode of operation based (e.g., based only) on the priority of the UL transmission and regardless of the measured RSRP, CLI, and/or frequency gap.

In some examples, the WTRU may be configured and/or receive an indication with a first set of threshold values (for example, for measurements such as RSRP, CLI, frequency gap, or other characteristics) for UL transmissions with a first priority level (e.g., a high priority level) and a second set of threshold values (for example, for measurements such as RSRP, CLI, frequency gap, or other characteristics) for UL transmissions with a second priority level (e.g., a low priority level). As such, the WTRU may use the first set of threshold values for determining the mode of operation based on measured RSRP, measured CLI, and/or determined frequency gaps, as described herein, in case the UL transmission has a first priority (e.g., high priority). The WTRU may use the second set of threshold values for determining the mode of operation based on measured RSRP, measured CLI, and/or determined frequency gaps, as described herein, in case the UL transmission has a second priority (e.g., low priority).

The WTRU may transmit or not transmit a configured, determined, and/or scheduled UL transmission in the UL subband and according to SBFD resources and/or configurations according to the above mentioned determined mode of the operation.

Methods for determining a CSI reporting configuration based on changes in an SBFD configuration associated with a neighbor cell are described herein. In some solutions, a WTRU may be configured, receive an indication, and/or determine a CSI reporting configuration for one or more target symbols based on one or more conditions, thresholds, measured parameters associated with a serving cell and/or one or more neighbor cells. In the detailed description provided herein, CSI reporting may include or refer to (or be interchangeably used to refer to) beam reporting, or any other type of reporting (e.g., RRM reporting, mobility related reporting, etc.) carried out by the WTRU. In some examples, report content(s) (e.g., report quantities) generated for beam reporting may include a CSI-RS resource (CRI) and/or SSB resource index (SSBRI) along with, or separately from, a beam quality or strength metric, such as (L1-)RSRP and/or (L1-)SINR. A beam quality or strength metric, such as (L1-)RSRP and/or (L1-)SINR may be included as a part of one or more CSI reports (e.g., RI, PMI, CQI, etc.) or may be separately configured for beam reporting. For example, the WTRU may determine, be configured, and/or receive an indication of one or more target symbols, where the target symbols may coincide in time with one or more (e.g., specially) indicated and/or configured symbols associated with a first neighbor cell. In some examples, the target symbols may be configured with configurations (e.g., SBFD), based on which the target symbols may at least include an UL subband and a DL subband.

In some examples, the WTRU may be configured with multiple (e.g., two) separate CSI report configurations in FD (e.g., SBFD) and non-FD (e.g., non-SBFD) time instances (e.g., symbols, slots, frames, etc.). In some examples, the WTRU may be configured with a first CSI reporting configuration that may be associated with CSI-RS(s) received and/or measured in (e.g., restricted to) symbols for operation under a first configuration (e.g., symbols configured for SBFD operation, located at least in an UL and a DL subband, e.g., in SBFD symbols). In some examples, the WTRU may be configured with a second CSI reporting configuration that may be associated with CSI-RS(s) received and/or measured in (e.g., restricted to) symbols for operation under a second configuration (e.g., symbols configured for non-SBFD operation, located in DL-only subbands, BWP, or other specific frequency resources).

In some solutions, a WTRU may determine whether to use or not to use the first (e.g., SBFD) CSI reporting configuration based on one or more conditions, measurements, and/or threshold values. In some examples, determining to use the first CSI reporting configuration may imply that the WTRU performs the configured measurements on one or more symbols, determines the measurement results or samples to be applied for measurement averaging (e.g., weighted averaging, time-domain moving average, averaging based on a function, etc.) with previous measurement results or samples performed on a second one or more symbols that are associated with the first CSI reporting configuration. For example, the WTRU may receive the corresponding configuration information, indications, and/or threshold values, for example via RRC, MAC-CE, DCI, etc.

A WTRU may determine a CSI reporting configuration based on a measured received power. For example, the WTRU may determine whether to use or not to use the first (e.g., SBFD) CSI reporting configuration based on a measured received power (e.g., RSRP, RSSI, RSRQ, CQI, etc.).

In some examples, if a measured received power (e.g., RSRP) associated with the serving cell is higher than a configured first (e.g., RSRP) threshold, the WTRU may determine to use the first (e.g., SBFD) CSI reporting configuration in the target symbols. An example of a WTRU that may determine to use the first CSI reporting configuration on this basis is illustrated in FIG. 2 by WTRU 212, which is located within or in close proximity to the center area of the serving cell 210 and the base station 211. The WTRU 212 may be configured to measure a received power associated with the serving cell 210, based on signals received from the base station 211. The WTRU 212 may determine which CSI reporting configuration to use in the target symbols based on the measured received power.

In some examples, the WTRU may determine to use the first (e.g., SBFD) CSI reporting configuration in the target symbols if a measured received power (e.g., RSRP) associated with the serving cell is lower than a configured first (e.g., RSRP) threshold and a measured received power (e.g., RSRP) associated with the first neighbor cell is lower than a configured second (e.g., RSRP) threshold.

In some examples, the WTRU may determine to not use the first (e.g., SBFD) CSI reporting configuration in the target symbols if a measured received power (e.g., RSRP) associated with the serving cell is lower than a configured first (e.g., RSRP) threshold and a measured received power (e.g., RSRP) associated with the first neighbor cell is higher than a configured second (e.g., RSRP) threshold.

In some examples, the WTRU may determine to not use the first (e.g., SBFD) CSI reporting configuration in the target symbols if a measured received power (e.g., RSRP) associated with a first neighbor cell is higher than a configured third (e.g., RSRP) threshold.

A WTRU may determine a CSI reporting configuration based on a measured CLI. In some examples, the WTRU may determine whether to use or not to use the first (e.g., SBFD) CSI reporting configuration based on a CLI (e.g., CLI-RSSI, SRS-RSRP, etc.) that may be measured based on the CLI received from the first neighbor cell, as described substantially in paragraphs above.

In some examples, the WTRU may determine to use the first (e.g., SBFD) CSI reporting configuration in the target symbols if a measured received CLI power and/or strength associated with the first neighbor cell is lower than a configured (e.g., CLI) threshold.

In some examples, the WTRU may determine to not use the first (e.g., SBFD) CSI reporting configuration in the target symbols if a measured received CLI power and/or strength associated with the first neighbor cell is higher than a configured (e.g., CLI) threshold.

In some solutions, a WTRU that has determined, is configured, and/or received an indication to not use the first (e.g., SBFD) CSI reporting configuration may determine, be configured, and/or receive an indication to use one or more other configured CSI reporting configurations. In some examples, the WTRU may receive one or more indications or configuration information regarding one or more other CSI reporting configurations to be used in such cases in target symbols. The one or more indications or configuration information may be provided, for example, via RRC, MAC-CE, DCI, or other logically equivalent signaling. One or more CSI reporting configurations may be used in such cases in target symbols, as described by way of example in paragraphs below.

A WTRU may determine to use a second (e.g., non-SBFD) CSI reporting configuration. For example, the WTRU may determine, be configured, and/or receive an indication to use the second (e.g., non-SBFD) CSI reporting configurations in the target symbols. In some examples, a determination to not use the first CSI reporting configuration may imply that the WTRU performs the configured measurements on one or more symbols, and determines the measurement results or samples to be applied for measurement averaging with previous measurement results or samples on a second one or more symbols that are associated with a CSI reporting configuration different from the first CSI reporting configuration (e.g., the second (e.g., non-SBFD) CSI reporting configuration). In some examples, a measurement average may be calculated through weighted averaging, time-domain moving averaging, averaging based on a function, or averaging via other methods. In some examples, the WTRU may indicate (e.g., to a base station, a network node such as a gNB, a TRP, or another network element) that the WTRU used the second CSI reporting configuration for the corresponding target symbols. For example, the WTRU may report and/or send the indication as part of a CSI report, for example, via a flag indication. In some examples, in the case the flag indication has a first value (e.g., value one), it may indicate the WTRU has used the first (e.g., SBFD) CSI reporting configuration. In another example, in the case the flag indication has a second value (e.g., value zero), it might indicate it has used the second (e.g., non-SBFD) CSI reporting configuration.

A WTRU may determine to use a subband-wise CSI reporting configuration. In some examples, the WTRU may determine, be configured, and/or receive an indication to use the subband-wise reporting configurations in the target symbols. In some examples, the WTRU may be (pre) configured and/or receive an indication of the subbands and/or frequency resources (e.g., REs, RBs, or other frequency domain resources) to be used for measuring CSI-RSs and/or reporting CSI in the target symbols. In some examples, the WTRU may determine, be configured, and/or receive an indication of one or more frequency resources (e.g., REs, RBs, or other frequency domain resources) for which the WTRU may puncture the mapped CSI-RS sequences. In some examples, the WTRU may indicate (e.g., to a base station, a network node such as a gNB, a TRP, or another network element) that the WTRU used the subband-wise CSI reporting configuration for the corresponding target symbols. For example, the WTRU may report and/or send the indication as part of CSI report, for example via a flag indication. In some examples, when the flag indication has a first value (e.g., a value of one), it may indicate the WTRU has used the subband-wise CSI reporting configuration. In some examples, when the flag indication has a second value (e.g., a value of zero), it may indicate the WTRU has not used the subband-wise CSI reporting configuration.

A WTRU may determine to skip or disregard measurements for CSI reporting in one or more target symbols. For example, the WTRU may determine, be configured, and/or indicated to not use the CSI-RS measurements associated with target symbols for CSI reporting. That is, the WTRU may not consider the received and/or measured CSI-RSs in target symbols for reporting CSI. For example, the WTRU may not use the measured parameters in the target symbols for averaging parameters for further CSI reporting. For example, the WTRU may consider the CSI-RS sequence mapped to the target symbols to be punctured. In some examples, the WTRU may indicate (e.g., to a base station, a network node such as a gNB, a TRP, or another network element) that the WTRU skipped using the CSI-RS measurements or that the WTRU disregarded the CSI-RS measurements performed in the corresponding target symbols. For example, the WTRU may report and/or send the indication as part of a CSI report, for example via a flag indication. In an example, in case the flag indication has a first value (e.g., a value of one), it may indicate the WTRU skipped using or disregarded the CSI-RS measurements. In some examples, in case the flag indication has a second value (e.g., a value of zero), it might indicate the WTRU has not skipped using or has not disregarded the CSI-RS measurements.

The WTRU may use the determined CSI reporting configuration in the target cell for CSI reporting.

Solutions for determining CSI reporting configuration based on SBFD configuration changes in a serving cell are described herein.

A WTRU may be configured, indicated, and/or receive configuration information and/or one or more indications, for example, of first and second configurations for one or more first symbols and one or more second symbols, respectively. For example, the WTRU may be configured with one or more first symbols associated with a first (e.g., FD, SBFD, etc.) configuration, based on which the first symbol may include at least an UL and a DL subband. In some examples, the WTRU may be configured with one or more second symbols associated with a second (e.g., non-FD, non-SBFD, etc.) configuration, based on which the second symbol may include (e.g., only include) UL or DL subbands, RBs, REs, frequency bands, BWPs, etc. The WTRU may receive the configuration information and/or indications via SIB, RRC, MAC-CE, DCI, or other logically equivalent signaling, for example.

In some examples, the WTRU may be configured with two separate CSI report configurations associated respectively with FD (e.g., SBFD) and non-FD (e.g., non-SBFD) time instances (e.g., symbols, slots, frames, or other time domain resources). In some examples, the WTRU may be configured with a first CSI reporting configuration that may be associated with CSI-RS(s) received and/or measured in (e.g., restricted to) symbols associated with a first configuration (e.g., including at least an UL and a DL subband, e.g., in SBFD symbols). In another example, the WTRU may be configured with a second CSI reporting configuration that may be associated with CSI-RS(s) received and/or measured in (e.g., restricted to) symbols associated with a second configuration (e.g., DL-only subbands, BWP, etc., e.g., in non-SBFD symbols). For example, the WTRU may receive the configuration information and/or indications via RRC, MAC-CE, DCI, or other logically equivalent signaling.

Converted symbols are described in greater detail herein. In some examples, a WTRU may determine, be configured, and/or receive an indication of one or more converted first symbols. A first symbol configured based on a first set of (e.g., SBFD) configurations may be converted to be used based on a second set of (e.g., non-SBFD, e.g., DL-only) configurations. The WTRU may receive indications on the converted symbols as described in further detail in paragraphs below.

The WTRU may determine the converted symbols based on an explicit indication. For example, the WTRU may receive one or more indications on the time span (e.g., start time, end time, time duration, etc.) during which the first symbols configured for use based on the first set of configurations may be converted to be used based on the second set of configurations. In some examples, the WTRU may receive one or more indications of the frequency span (e.g., start frequency resources, end frequency, frequency duration, etc), which may be expressed based on frequency units (e.g., kHz) and/or a number of REs, RBs, subbands, or another type of frequency domain resource. The first symbols within the frequency span, may be converted, based on the first set of configurations, to be considered based on the second set of configurations. In some examples, the WTRU may receive configuration information and/or indications of the first symbols to be converted. In some examples, the WTRU may receive configuration information and/or indications of the second configurations to be used for the converted symbols. For example, the WTRU may receive the configuration information and/or indications via RRC, MAC-CE, DCI, or other logically equivalent signaling.

The WTRU may determine the converted symbols based on an implicit indication. For example, the WTRU may implicitly determine the converted symbols, for example based on one or more conditions. One or more of the conditions supporting an implicit indication may be satisfied as described in paragraphs below.

An implicit indication of converted symbols may be provided by an SSB transmission. In some examples, a WTRU may be configured with a first symbol based on the first (e.g., SBFD) set of configurations. The WTRU may be configured and/or receive an indication that a SSB transmission coincides with the first symbol. As such, the WTRU may be configured and/or may receive an indication to treat or consider the first symbol as a converted symbol, for example with the second (e.g., DL-only, e.g., non-SBFD) set of configurations. That is, for example, the WTRU may not transmit an UL transmission in the configured UL subbands in the first symbol if the first symbol coincides in time with one or more SSB transmissions.

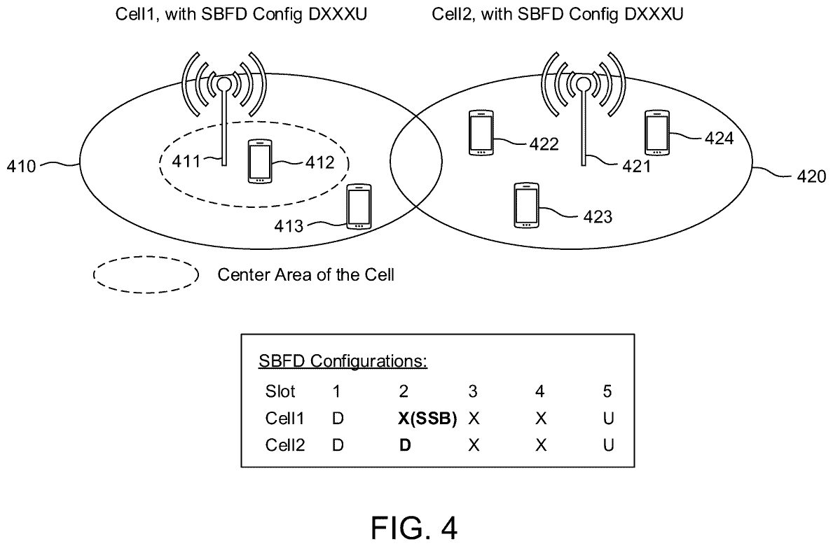

FIG. 4 is a diagram illustrating an example scenario in which an SSB transmission performed in one cell may serve as an indication to convert SBFD resources configured for the cell. As shown in FIG. 4, WTRUs 412 and 413 are present within a first cell 410. The cell 410 (i.e., base station 411 and WTRUs 412 and 413) are be configured with resources (e.g., symbols and/or slots) for use in an SBFD mode of operation. As shown in FIG. 4, the cell 410 is located adjacent to a second cell 420 in which a base station 421 and WTRUs 422, 423, and 424 are present. In cell 420, the base station 421 and WTRUs 422, 423, and 424 may also be configured with resources for use in the SBFD mode operation. In the example shown in FIG. 4, similar to the example described above with respect to FIG. 2, both cells 410 and 420 are configured with a DXXXU TDD configuration, where D represents a downlink slot, U represents an uplink slot, and X represents a flexible (e.g., downlink or uplink) slot for SBFD operation.

The base station 411 associated with the first cell 410 may be transmitting SSBs, and one or more SSBs may be transmitted during SBFD symbols and/or slots configured at the second cell 420. The one or more SSBs may be transmitted in one or more DL symbols or slots of the first cell 410. These symbols or slots of the first cell 410 may be configured for SBFD operation in the first cell 410, but may be converted from SBFD symbols or slots to DL symbols or slots due to the presence of the SSB transmissions.

As is illustrated in FIG. 4, an SSB configured for transmission by the base station 411 in slot 2, which is (e.g., originally) configured as SBFD slot in the first cell 410, may serve as an implicit indication that the first slot configured as an SBFD slot in the first cell 410 should be converted to a DL symbol.

In another example, an implicit indication of converted symbols may be provided by a Cell DRX (i.e., a Cell DRX occasion or cycle). In an example, a WTRU may be configured with a first symbol associated with the first (e.g., SBFD) set of configurations, where the WTRU is configured and/or may receive an indication that a cell DRX occasion of the serving cell may coincide with the first symbol. For example, the WTRU may receive configuration information on time locations where a cell DRX occasion, for example in Network Energy Saving (NES) framework context, may be configured. As such, the WTRU may be configured and/or indicated to consider the first symbol as a converted symbol, for example based on the second (e.g., DL-only, e.g., non-SBFD) configuration. That is, for example, the WTRU may not transmit an UL transmission in the configured UL subbands in the first symbol if the first symbol coincides in time with one or more cell DRX occasions.

Solutions for determining a CSI reporting configuration for the converted symbols are described herein. In some solutions, a WTRU may determine the CSI reporting configuration type to be used in a converted first symbol based on one or more measurements, conditions, and/or threshold values. In an example, the that first symbol configured based on a first (e.g., FD or SBFD) configuration is determined, indicated, and/or configured may be indicated, configured, and/or determined to be converted for use with a second (e.g., non-FD, non-SBFD) configuration. For example, the WTRU may receive threshold values, the configuration information, and/or one or more indications of the conversion of the first symbol via RRC, MAC-CE, DCI, or other logically equivalent signaling.

In some solutions, a WTRU may determine, be configured, enabled, and/or receive an indication whether to use or not to use the second (e.g., non-SBFD) CSI reporting configurations in one or more converted first symbols, based on one or more conditions and/or threshold values. For example, the WTRU may receive configuration information, enable/disable indications, threshold values, or other information, for example via RRC, MAC-CE, DCI, or other logically equivalent signaling. One or more of the following conditions may apply:

The WTRU may determine whether to use the second CSI reporting configurations based on a measured received power. For example, the WTRU may determine, be configured, enabled, and/or indicated to determine on whether to use or not use the second (e.g., non-SBFD) CSI reporting configurations in one or more converted first symbols based on measured received power.

In some examples, if a measured received power (e.g., RSRP) associated with a serving cell is higher than a configured first (e.g., RSRP) threshold, the WTRU may determine, be configured, enabled, and/or receive an indication to use the second (e.g., non-SBFD) CSI reporting configuration in the converted first symbols.

An example of a WTRU that may use a non-SBFD CSI reporting configuration in converted symbols is illustrated in FIG. 4, introduced and described substantially in paragraphs above, which shows a WTRU 412 that is positioned within or in close proximity to a center area of the first serving cell 410 and away from the neighbor cell 420 that may cause CLI potentially impacting the CSI reporting. As the WTRU 412 is positioned closer to the serving cell 410 than the neighbor cell 420, it may be likely that the measured received power associated with the serving cell is higher than a threshold value, and, in this example, the WTRU 412 may be configured to use the non-SBFD CSI reporting configuration.

In some examples, a WTRU may determine, be configured, enabled, and/or receive an indication to not use the second (e.g., non-SBFD) CSI reporting configuration in the converted first symbols if a measured received power (e.g., RSRP) associated with the serving cell is lower than the configured first (e.g., RSRP) threshold and the measured received power (e.g., RSRP) associated with a first neighbor cell is higher than a configured second (e.g., RSRP) threshold.

An example of a WTRU that may be configured to not use a non-SBFD CSI reporting configuration in converted symbols is illustrated in FIG. 4, introduced and described substantially in paragraphs above. As shown in FIG. 4, the WTRU 413 is positioned outside of a center area of the first serving cell 410 and in closer proximity to the neighbor cell 420 than the WTRU 412. Due to the positioning of the WTRU 413, for example, it may be likely that the measured received power associated with the serving cell is lower than a threshold value, while a measured received power associated with the neighbor cell 420 is greater than another threshold. If so, in this example, the WTRU 413 may be configured to not use the non-SBFD CSI reporting configuration.

In some examples, a WTRU may determine, be configured, enabled, and/or receive an indication to use the second (e.g., non-SBFD) CSI reporting configuration in the converted first symbols if a measured received power (e.g., RSRP) associated with the serving cell is lower than the configured first (e.g., RSRP) threshold and a measured received power (e.g., RSRP) associated with the first neighbor cell is lower than the configured second (e.g., RSRP) threshold.

In some examples, the WTRU may determine, be configured, enabled, and/or receive an indication to not use the second (e.g., non-SBFD) CSI reporting configuration in the converted first symbols if the measured received power (e.g., RSRP) based on the first neighbor cell is higher than a configured third (e.g., RSRP) threshold.

The WTRU may determine whether to use the second CSI reporting configurations based on a measured CLI. For example, the WTRU may be configured, enabled, and/or receive an indication to determine whether to use or not to use the second (e.g., non-SBFD) CSI reporting configuration based on a measured CLI (e.g., a CLI-RSSI, SRS-RSRP, or another interference metric). The measured CLI may be representative of the CLI experienced over a link to a first neighbor cell, as described herein.

In some examples, the WTRU may determine, be configured, enabled, and/or receive an indication to use the second (e.g., non-SBFD) CSI reporting configuration in the converted first symbols if the measured received CLI power and/or strength based on the first neighbor cell is lower than a configured threshold (e.g., a CLI threshold).

In some examples, the WTRU may determine, be configured, enabled, and/or receive an indication to not use the second (e.g., non-SBFD) CSI reporting configuration in the converted first symbols, if the measured received CLI power and/or strength based on the first neighbor cell is higher than the configured (e.g., CLI) threshold.

In some examples, a WTRU that has determined, is configured, and/or received an indication to not use the second (e.g., non-SBFD) CSI reporting configuration may determine, be configured, and/or receive an indication to use one or more other configured CSI reporting configurations in one or more converted first symbols. In some examples, the WTRU may receive one or more configuration information and/or indications on the other CSI reporting configurations to be used in such cases in converted symbols, for example via RRC, MAC-CE, DCI, or other logically equivalent signaling. One or more of the CSI reporting configurations as described by way of example in the following paragraphs may be used in such cases in the converted first symbols.

In some examples, a first (e.g., SBFD) CSI reporting configuration may be used. For example, the WTRU may determine, be configured, and/or receive an indication to use the first (e.g., SBFD) CSI reporting configurations in the converted first symbols. In some examples, the WTRU may indicate (e.g., to a base station, a node such as a gNB, a TRP, or another network element) that WTRU used the first CSI reporting configuration for the corresponding converted first symbols. For example, the WTRU may report and/or send the indication as part of a CSI report, for example via a flag indication. In some examples, if the flag indication has a first value (e.g., a value of one), the flag indication may indicate the first (e.g., SBFD) CSI reporting configuration is used. In another example, in case the flag indication has a second value (e.g., a value of zero), the flag indication may indicate the second (e.g., non-SBFD) CSI reporting configuration is used.

In some examples, a subband-wise CSI reporting configuration may be used. For example, the WTRU may determine, be configured, and/or receive an indication to use the subband-wise reporting configurations in the converted first symbols. In some examples, the WTRU may be (pre) configured and/or receive an indication of the subbands and/or frequency resources (e.g., REs, RBs, or another frequency domain resource) to be used for measuring CSI-RSs and/or reporting CSI in the converted first symbols. In some examples, the WTRU may determine, be configured, and/or receive an indication of one or more frequency resources (e.g., REs, RBs, or another frequency domain resource) for which the WTRU may puncture the mapped CSI-RS sequences. In an example, the WTRU may indicate (e.g., to a base station, a node such as a gNB, a TRP, or another network element) that WTRU used the subband-wise CSI reporting configuration for the corresponding converted first symbols. For example, the WTRU may report and/or send the indication as part of a CSI report, for example via a flag indication. In some examples, if the flag indication has a first value (e.g., a value of one), the flag indication may indicate the subband-wise CSI reporting configuration is used. In another example, if the flag indication has a second value (e.g., a value of zero), it may indicate the subband-wise CSI reporting configuration is not used.

In some examples, the measurements for CSI reporting in converted first symbols may be skipped or disregarded. For example, the WTRU may determine, be configured, and/or indicated to not use the CSI-RS measurements in the converted first symbols for CSI reporting. That is, the WTRU may not consider the received and/or measured CSI-RSs in converted first symbols for reporting CSI. For example, the WTRU may not use the measured parameters in the converted first symbols for averaging parameters for further CSI reporting. For example, the WTRU may consider the CSI-RS sequence mapped to the converted first symbols to be punctured. In an example, the WTRU may indicate (e.g., to a base station, a node such as a gNB, a TRP, or another network element) that the WTRU skipped using or disregarded the CSI-RS measurements based on the corresponding converted first symbols. For example, the WTRU may report and/or send the indication as part of a CSI report, for example via a flag indication. In some examples, if the flag indication has a first value (e.g., a value of one), it may indicate the CSI-RS measurements were skipped or disregarded. In some examples, if the flag indication has a second value (e.g., a value of zero), it might indicate the CSI-RS measurements were not skipped or disregarded.

The WTRU may use the determined CSI reporting configuration in the converted first cell for CSI reporting.

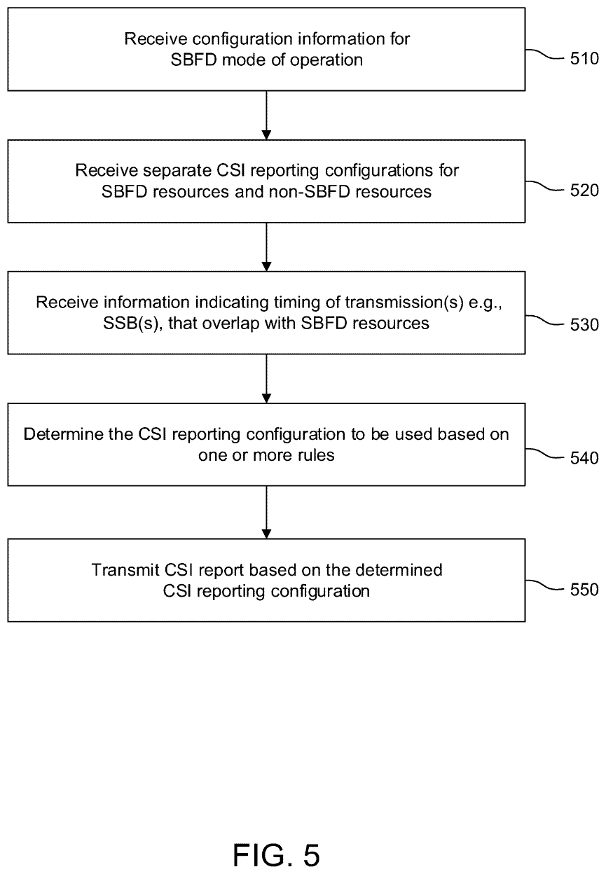

FIG. 5 is a flow diagram illustrating steps as may be performed by a WTRU for determining a CSI reporting configuration, consistent with one or more examples described above. As shown in FIG. 5, at 510, a WTRU may receive configuration information for an SBFD mode of operation. For example, the WTRU may be semi-statically configured with SBFD resources (e.g., symbols within a TDD cycle). The resources may be configured, for example, for SBFD operation within a serving cell. As shown at 520, the WTRU receives separate CSI reporting configurations for SBFD resources and non-SBFD resources. In some examples, the WTRU is configured with separate CSI report configurations (or, in some examples, may receive a single information element (e.g., CSI-ReportConfig) providing separate sub-configurations), where one configuration (or a sub-configuration provided by CSI-ReportConfig) is associated with CSI-RS(s) restricted to SBFD symbols only. The second configuration (or sub-configuration provided by CSI-ReportConfig) is associated with CSI-RS(s) restricted to non-SBFD symbols only.

As shown at 530, the WTRU receives information indicating the timing of one or more DL, SSB, CSI-RS, DM-RS, etc. transmissions (e.g., scheduled in a neighboring cell) that at least partially overlap with the configured SBFD resources. For example, the WTRU may determine that a collision will occur between a configured SBFD resource and an SSB transmission scheduled in a neighboring cell. The WTRU may determine that a configured SBFD symbol should be considered a DL-only symbol, e.g., due to the impending SSB transmission.

As shown at 540, the WTRU determines whether to use SBFD or non-SBFD CSI reporting configurations (if configured SBFD symbol is converted to DL-only symbol in the serving cell), based on one or more rules. Such rules may be based on one or more conditions, described as follows.

The rules for determining the CSI reporting configuration may be based on a measurement associated with the serving cell. For example, the WTRU may determine to use non-SBFD CSI reporting if the serving cell's RSRP exceeds a threshold value. FIG. 4, introduced and described in greater detail in paragraphs above, illustrates an example of a WTRU 412 that may be configured to use non-SBFD CSI reporting, based on a measurement associated with the serving cell, given the proximity of the WTRU 412 to the center area of the serving cell 410.

In some examples, the WTRU may determine to not use non-SBFD CSI reporting, such as when a measurement associated with the serving cell is below a threshold. For example, the WTRU may determine to not use non-SBFD CSI reporting if the serving cell's RSRP is less than a threshold. FIG. 4 again illustrates another example of a WTRU 413 that may be configured to not use non-SBFD CSI reporting, based on a measurement associated with the serving cell, given the distance of the WTRU 413 from the center area of the serving cell 410.

A benefit of determining the CSI reporting configuration based on a measurement associated with the serving cell is that WTRUs at or near to the cell border may have a higher potential to experience inter-cell CLI on frequency resources outside DL-usable PRBs, for example, from neighbor cells utilizing similar SBFD configurations. It is also beneficial to utilize as many occasions as possible to perform more SBFD measurements (e.g., for accuracy in averaging).

In some embodiments, the rules for determining the CSI reporting configuration may be based on other factors. For example, a WTRU may use non-SBFD CSI reporting if it measured a CLI less than a threshold. A WTRU may determine to not use non-SBFD CSI reporting if a measured CLI exceeds a threshold.

It should be understood that the example shown in FIG. 5 is merely one example, and one or more steps may be performed in accordance with other methods described elsewhere herein. As shown in FIG. 5 at 550, once the WTRU has determined the CSI report configuration to be used, the WTRU transmits a CSI report in accordance with the determination.

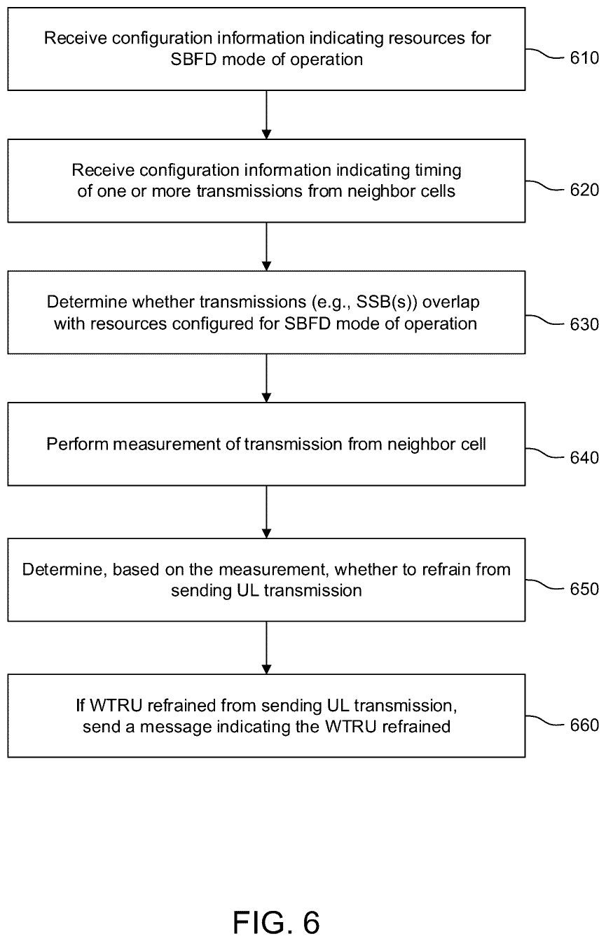

FIG. 6 is a flow diagram illustrating steps as may be performed by a WTRU for determining a mode of operation (e.g., an SBFD or non-SBFD mode of operation). As shown at 610, a WTRU receives configuration information (e.g., via RRC signaling, or other logically equivalent signaling) indicating resources (e.g., a plurality of symbols and/or slots associated with a serving cell) for SBFD operation. The resources may be configured, e.g., within a TDD cycle, and/or with at least one subband for DL operation and one subband for UL operation.

As shown at 620, the WTRU receives configuration information indicating the timing (e.g., time locations) of one or more transmissions (e.g., SSBs) in each of one or more other (e.g., neighbor) cells. The configuration information indicating the timing may be received via a WTRU-specific, group-common, and/or cell-common signaling (e.g., RRC and/or MAC-CE, or other logically equivalent signaling) or the configuration information may be obtained by receiving and reading a SIB from one or more of the configured neighbor cells. In some examples, the WTRU may receive indications of time locations of SBFD symbols in each of the one or more other (e.g., neighbor) cells. The reception of other (e.g., neighbor) cell information may provide information for up to a given number cells and may include the physical cell-ID (PCID) of the cell. In such cases, the given number of cells may be configurable per WTRU.

As shown at 630, the WTRU may determine whether the transmissions in each of the neighbor cells overlap with the configured SBFD resources. For example, the WTRU may determine whether a SSB (e.g., a first SSB or any SSB) of a (e.g., a first) other (e.g., neighbor) cell overlaps in time with a (e.g., any) symbol or slot configured for SBFD operation in the serving cell. The overlapping symbols or slots may be denoted as target symbols or slots.

As shown at 640, the WTRU performs a measurement of a transmission from at least one neighbor cell. For example, the WTRU may measure an RSRP of an SSB (e.g., the first or any SSB) of another cell that is determined to overlap in time with a target symbol or slot.

As shown at 650, if the WTRU is scheduled to transmit an UL transmission in at least a target symbol or target slot configured for SBFD operation and the target symbol or slot overlaps in time with the SSB of the other (e.g., first other) cell, the WTRU determines whether to transmit the UL transmission in the target symbol or target slot based on the measured RSRP of the SSB, or whether to refrain from transmitting the UL transmission. In some examples, the WTRU transmits the UL transmission in the target symbol or target slot when the measured RSRP of the SSB of the other cell is lower than a configured RSRP threshold. In some examples, the WTRU does not transmit the UL transmission in the target symbol or slot when the measured RSRP of the SSB of the other cell is higher than the configured RSRP threshold.

In some examples, as shown in FIG. 6 at 660, the WTRU sends a message to indicate to the network (e.g., to a base station, a node such as a gNB, a TRP, or another network element) that the WTRU refrained from sending the UL transmission due to coincidence with the SSB. The indication may be carried via a flag indication as part of a specific SR, HARQ-ACK, or other information in a next configured transmission or another UL transmission.

The determination whether or not to transmit the UL transmission in the target symbols or slots may be conditioned (e.g., further conditioned) on a frequency gap between the UL transmission and the SSB. For example, the WTRU may transmit the UL transmission in the target symbols or slots when the frequency gap is greater than a configured frequency threshold, even if the RSRP of the SSB is higher than the RSRP threshold.

In some examples, there may be multiple RSRP thresholds that may be used in combination with respective multiple frequency gaps to determine whether the WTRU transmits the UL transmission.

In some examples, the determination whether or not to transmit the UL transmission may be conditioned (e.g., further conditioned) on a type or priority of the UL transmission. For example, an UL transmission scheduled by a grant (e.g., a dynamic grant) in the target symbols or slots indicated (e.g., in the associated DCI) to have a first (e.g., high) priority may be transmitted regardless of the RSRP of the SSB and/or the frequency gap.

In some examples, whether to transmit an UL transmission scheduled by a grant (e.g., a dynamic grant) in the target symbols or slots indicated (e.g., in the associated DCI) to have a second (e.g., lower) priority may be determined based on the RSRP and/or frequency gap conditions.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A wireless transmit/receive unit (WTRU) comprising:
a processor; and
a transceiver;
the processor and the transceiver configured to receive configuration information for a serving cell indicating a plurality of uplink (UL) resources associated with a subband full duplex (SBFD) mode of operation;
the processor and the transceiver configured to receive timing information for one or more synchronization signal block (SSB) transmissions associated with a neighbor cell;
the processor configured to determine, based on the configuration information and the timing information that at least one of the one or more SSB transmissions will overlap in time with one of the plurality of UL resources associated with the SBFD mode of operation;
the processor configured to receive scheduling information indicating at least one of the plurality of UL resources associated with the SBFD mode to send an UL transmission, wherein the at least one of the plurality of UL resources associated with the SBFD mode will overlap in time with the at least one of the one or more SSB transmissions;
the processor and the transceiver configured to measure a reference signal received power (RSRP) of an SSB transmission associated with the neighbor cell;
the processor configured to, based on a measurement of the RSRP of the SSB transmission associated with the neighbor cell exceeding an RSRP threshold, determine to refrain from sending the UL transmission; and
the processor and the transceiver configured to send a message to a base station associated with the serving cell, wherein the message indicates the WTRU refrained from sending the UL transmission.

2. The WTRU of claim 1, the processor further configured to determine whether to refrain from sending the UL transmission in the one of the plurality of resources associated with the SBFD mode overlapped in time by the at least one of the one or more SSB transmissions based on a frequency gap between a frequency of the at least one of the one or more SSB transmissions and a frequency of the one of the plurality of UL resources associated with the SBFD mode overlapped in time by the at least one of the one or more SSB transmissions.

3. The WTRU of claim 2, wherein the processor is configured to compare one of a plurality of frequency thresholds with the frequency gap between the at least one of the one or more SSB transmissions and the at least one of the plurality of UL resources associated with the SBFD mode overlapped in time, wherein one or more RSRP thresholds are selected from a plurality of RSRP thresholds based on the determined frequency gap and one or more configured frequency thresholds.

4. The WTRU of claim 1, wherein the message indicating the WTRU refrained from sending the UL transmission comprises uplink control information including one or more of a scheduling request (SR) or hybrid acknowledgement repeat request (HARQ) feedback.

5. The WTRU of claim 1, the processor further configured to determine whether to refrain from sending the UL transmission based on a priority of the scheduled UL transmission.

6. The WTRU of claim 1, wherein the plurality of UL resources associated with the SBFD mode of operation comprises a plurality of symbols.

7. The WTRU of claim 1, wherein the plurality of UL resources associated with the SBFD mode of operation comprises a plurality of slots.

8. A method performed by a wireless transmit/receive unit (WTRU), the method comprising:
receiving configuration information for a serving cell indicating a plurality of uplink (UL) resources associated with a subband full duplex (SBFD) mode of operation;
receiving timing information for one or more synchronization signal block (SSB) transmissions associated with a neighbor cell;
determining, based on the configuration information and the timing information that at least one of the one or more SSB transmissions will overlap in time with one of the plurality of UL resources associated with the SBFD mode of operation;
receiving scheduling information indicating at least one of the plurality of UL resources associated with the SBFD mode to send an UL transmission, wherein the at least one of the plurality of UL resources associated with the SBFD mode will overlap in time with the at least one of the one or more SSB transmissions;
measuring a reference signal received power (RSRP) of an SSB transmission associated with the neighbor cell;
determining, based on a measurement of the RSRP of the SSB transmission associated with the neighbor cell exceeding an RSRP threshold, to refrain from sending the UL transmission; and
sending, a message to a base station associated with the serving cell, wherein the message indicates the WTRU refrained from sending the UL transmission.

9. The method of claim 8 further comprising determining whether to refrain from sending the UL transmission in the one of the plurality of resources associated with the SBFD mode overlapped in time by the at least one of the one or more SSB transmissions based on a frequency gap between a frequency of the at least one of the one or more SSB transmissions and a frequency of the one of the plurality of UL resources associated with the SBFD mode overlapped in time by the at least one of the one or more SSB transmissions.

10. The method of claim 9 comprising comparing one of a plurality of frequency thresholds with the frequency gap between the at least one of the one or more SSB transmissions and the at least one of the plurality of UL resources associated with the SBFD mode overlapped in time, wherein one or more RSRP thresholds are selected from a plurality of RSRP thresholds based on the determined frequency gap and one or more configured frequency thresholds.

11. The method of claim 8, wherein the message indicating the WTRU refrained from sending the UL transmission comprises uplink control information including one or more of a scheduling request (SR) or hybrid acknowledgement repeat request (HARQ) feedback.

12. The method of claim 8 further comprising determining whether to refrain from sending the UL transmission based on a priority of the scheduled UL transmission.

13. The method of claim 8, wherein the plurality of UL resources associated with the SBFD mode of operation comprises a plurality of symbols.

14. The method of claim 8, wherein the plurality of UL resources associated with the SBFD mode of operation comprises a plurality of slots.

15. A wireless transmit/receive unit (WTRU) comprising:
a processor; and
a transceiver;
the processor and the transceiver configured to receive first configuration information indicating resources associated with a subband full duplex (SBFD) mode of operation in a serving cell;
the processor and the transceiver configured to receive information indicating one or more set of resources for determining channel state information (CSI), wherein the configured one or more set of resources for determining CSI may be from a first set of resources or a second set of resources, wherein the first set of resources are part of the resources associated with the SBFD mode of operation, and wherein the second set of resources are not part of the resources associated with the SBFD mode of operation
the processor and the transceiver configured to receive information indicating a first CSI report configuration and a second CSI report configuration wherein the first CSI report configuration provides parameters for reporting CSI determined based on the first set of resources, and wherein the second CSI report configuration provides parameters for reporting CSI determined based on the second set of resources;
the processor and the transceiver configured to receive timing information for one or more synchronization signal block (SSB) transmissions associated with the serving cell;
the processor configured to determine, based on the received timing information, that at least one of the first set of resources will overlap in time with the one or more SSB transmissions;
the processor configured to determine CSI based on the first set of resources that overlap in time with the one or more SSB transmissions;
the processor configured to determine, based on one or more of a measured reference signal received power (RSRP) associated with the serving cell or a measured crosslink interference (CLI), to report the measured CSI from one or more reference signals received in the first set of resources using the first CSI report configuration or using the second CSI report configuration;
the processor and the transceiver configured to send, to a base station associated with the serving cell, a CSI report including CSI determined based on the first set of resources or in the second set of resources.

16. The WTRU of claim 15, the processor configured to send the CSI report using the first CSI report configuration on a condition the RSRP associated with the serving cell is less than a threshold, wherein the first CSI report comprises information based on measurements of one or more reference signals received in the first set of resources.

17. The WTRU of claim 15, the processor configured to use the CSI that is determined based on one or more reference signals received in the first set of resources for the second report configuration on a condition the RSRP associated with the serving cell exceeds a threshold.

18. The WTRU of claim 15, the processor configured to use the CSI that is determined based on one or more reference signals received in the first set of resources for the first CSI report configuration on a condition the measured CLI exceeds a threshold.

19. The WTRU of claim 15, the processor configured to use the CSI that is determined based on one or more reference signals received in the first set of resources for the first CSI report configuration on a condition the measured CLI is less than a threshold.
